(19) United States
(12) Patent Application Publication
(10) Pub. No.: US 2026/0104574 A1
(43) Pub. Date: Apr. 16, 2026

(54) ZOOM LENS, IMAGE PICKUP APPARATUS, AND IMAGING SYSTEM

(71) Applicant: CANON KABUSHIKI KAISHA, Tokyo (JP)

(72) Inventors: Nobuyuki MIYAZAWA, Tochigi (JP); Kenta SUDO, Tochigi (JP); Shuichi KUROKAWA, Saitama (JP)

(21) Appl. No.: 19/332,040

(22) Filed: Sep. 18, 2025

(30) Foreign Application Priority Data
Oct. 11, 2024 (JP) 2024-178565
Oct. 11, 2024 (JP) 2024-178590
Oct. 11, 2024 (JP) 2024-178607

(51) Int. Cl. G02B 13/00; G02B 7/02; G02B 15/14

(52) U.S. Cl. CPC G02B 13/009; G02B 7/025; G02B 13/006; G02B 15/1461

(57) ABSTRACT

Zoom lenses, image pickup apparatuses, and imaging systems are provided herein. One or more zoom lenses may include a plurality of lens units that include, in order from an object side to an image side, a first lens unit with positive refractive power, a second lens unit with negative refractive power, an intermediate group consisting of one or two lens units with positive refractive power, a rear unit with negative refractive power, and a final unit with positive refractive power. The second lens unit includes five or more lenses. Each distance between adjacent lens units changes during zooming. A predetermined inequality is satisfied.

### BACKGROUND

### Field of the Technology

The aspect of the disclosure relates to one or more embodiments of a zoom lens, an image pickup apparatus, and an imaging system.

### Description of the Related Art

One of the conventional zoom lenses, which is small and can efficiently secure a proper zoom ratio, includes first to fifth lens units, which are arranged in this order from the object side to the image side, and have positive, negative, positive, negative, and positive refractive powers.

### SUMMARY

One or more embodiments of a zoom lens according to one or more aspects of the disclosure may include a plurality of lens units that include, in order from an object side to an image side, a first lens unit with positive refractive power, a second lens unit with negative refractive power, an intermediate group consisting of one or two lens units with positive refractive power, a rear unit with negative refractive power, and a final unit with positive refractive power. The second lens unit may include five or more lenses. Each distance between adjacent lens units may change during zooming. The following inequalities may be satisfied:

$$- 20. \leq M 3 / M 5 \leq - 2.2$$

$$- 6. \leq M 2 / M 3 \leq - 1.5$$

where M2 is a moving amount of the second lens unit during zooming from a wide-angle end to a telephoto end, M3 is a moving amount of a lens unit disposed closest to an object in the intermediate group during zooming from the wide-angle end to the telephoto end, M5 is a moving amount of the final unit during zooming from the wide-angle end to the telephoto end, and M2, M3, and M5 have positive signs in a case where a corresponding lens unit is disposed closer to an image plane at the telephoto end than at the wide-angle end.

One or more embodiments of a zoom lens according to one or more aspects of the disclosure may include a plurality of lens units that include, in order from an object side to an image side, a first lens unit with positive refractive power, a second lens unit with negative refractive power, an intermediate group with positive refractive power, a rear unit with negative refractive power, and a final unit with positive refractive power. The second lens unit includes five or more lenses. Each distance between adjacent lens units changes during zooming. The following inequality is satisfied:

$$- 20. \leq M 3 / M 5 \leq - 2.6$$

where M3 is a moving amount of a lens unit disposed closest to an object in the intermediate group during zooming from a wide-angle end to a telephoto end, M5 is a moving amount of the final unit during zooming from the wide-angle end to the telephoto end, and M3 and M5 have positive signs in a case where a corresponding lens unit is disposed closer to an image plane at the telephoto end than at the wide-angle end.

One or more embodiments of an image pickup apparatus and an imaging system may include one or more zoom lenses in accordance with one or more other aspects of the disclosure.

Features of the disclosure will become apparent from the following description of embodiments with reference to the attached drawings. The following description of embodiments is described by way of example.

### BRIEF DESCRIPTION OF THE DRAWINGS

FIG. 1 is a sectional view of a zoom lens according to Example 1.

FIGS. 2A, 2B, and 2C are aberration diagrams of the zoom lens according to Example 1 at a wide-angle end, an intermediate zoom position (intermediate focal length), and a telephoto end, respectively.

FIG. 3 is a sectional view of a zoom lens according to Example 2.

FIGS. 4A, 4B, and 4C are aberration diagrams of the zoom lens according to Example 2 at a wide-angle end, an intermediate zoom position, and a telephoto end, respectively.

FIG. 5 is a sectional view of a zoom lens according to Example 3.

FIGS. 6A, 6B, and 6C are aberration diagrams of the zoom lens according to Example 3 at a wide-angle end, an intermediate zoom position, and a telephoto end, respectively.

FIG. 7 is a sectional view of a zoom lens according to Example 4.

FIGS. 8A, 8B, and 8C are aberration diagrams of the zoom lens according to Example 4 at a wide-angle end, an intermediate zoom position, and a telephoto end, respectively.

FIG. 9 is a sectional view of a zoom lens according to Example 5.

FIGS. 10A, 10B, and 10C are aberration diagrams of the zoom lens according to Example 5 at a wide-angle end, an intermediate zoom position, and a telephoto end, respectively.

FIG. 11 is a sectional view of a zoom lens according to Example 6.

FIGS. 12A, 12B, and 12C are aberration diagrams of the zoom lens according to Example 6 at a wide-angle end, an intermediate zoom position, and a telephoto end, respectively.

FIG. 13 is a sectional view of a zoom lens according to Example 7.

FIGS. 14A, 14B, and 14C are aberration diagrams of the zoom lens according to Example 7 at a wide-angle end, an intermediate zoom position, and a telephoto end, respectively.

FIG. 15 is a sectional view of a zoom lens according to Example 8.

FIGS. 16A, 16B, and 16C are aberration diagrams of the zoom lens according to Example 8 at a wide-angle end, an intermediate zoom position, and a telephoto end, respectively.

FIG. 17 is a sectional view of a zoom lens according to Example 9.

FIGS. 18A, 18B, and 18C are aberration diagrams of the zoom lens according to Example 9 at a wide-angle end, an intermediate zoom position, and a telephoto end, respectively.

FIG. 19 is a schematic diagram of an image pickup apparatus.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

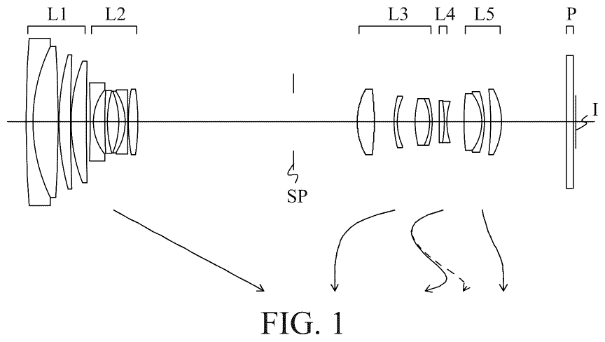

FIGS. 1, 3, 5, 7, 9, 11, 13, 15, and 17 are cross-sectional views of zoom lenses according to Examples 1 to 9, respectively. The zoom lens according to each example is used for image pickup apparatuses such as digital video cameras, digital still cameras, broadcasting cameras, film-based cameras, surveillance cameras, and vehicle mounted cameras (on-board cameras).

In each cross-sectional view, a left is an object side and a right side is an image side. The zoom lens according to each example may also be used as a projection lens for projectors and the like. In this case, a left side is a screen side and a right side is a projected image side.

The zoom lens according to each example includes a plurality of lens units. In this specification, a lens unit refers to a group of lenses that move or remain stationary as a unit during zooming (variable magnification). That is, in the zoom lens according to each example, each distance between adjacent lens units changes during zooming. Each lens unit may include one or more lenses. The lens unit may also include an aperture stop (diaphragm).

In each cross-sectional diagram, Li represents an i-th lens unit (where i is a natural number) included in the zoom lens, counted from the object side.

SP represents an aperture stop. I represents an image plane. In a case where the zoom lens according to each example is used as an imaging optical system in a digital still camera or digital video camera, an imaging surface of an image sensor (photoelectric conversion element) such as a CCD sensor or CMOS sensor is placed on the image plane I. In a case where the zoom lens according to each example is used as an imaging optical system in a film-based camera, a photosensitive surface equivalent to the film surface is placed on image plane I. P represents a glass block such as the faceplate of a CCD sensor or a low-pass filter.

In each example, during zooming from the wide-angle end to the telephoto end, each lens unit moves as illustrated by the arrows. Solid and dotted arrows represent moving loci (trajectories) during focusing on an object at infinity and a close object, respectively.

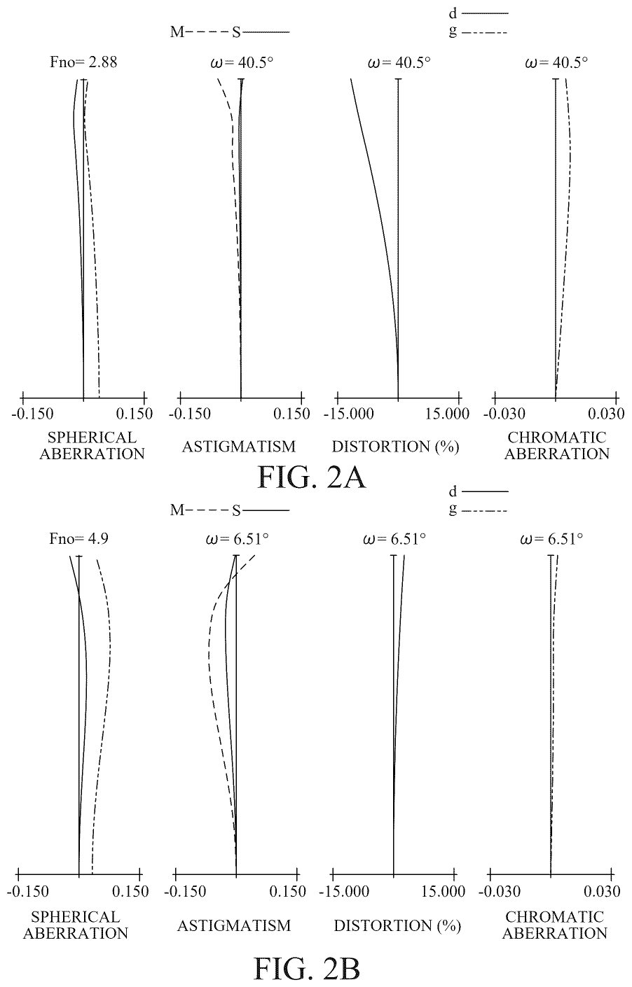

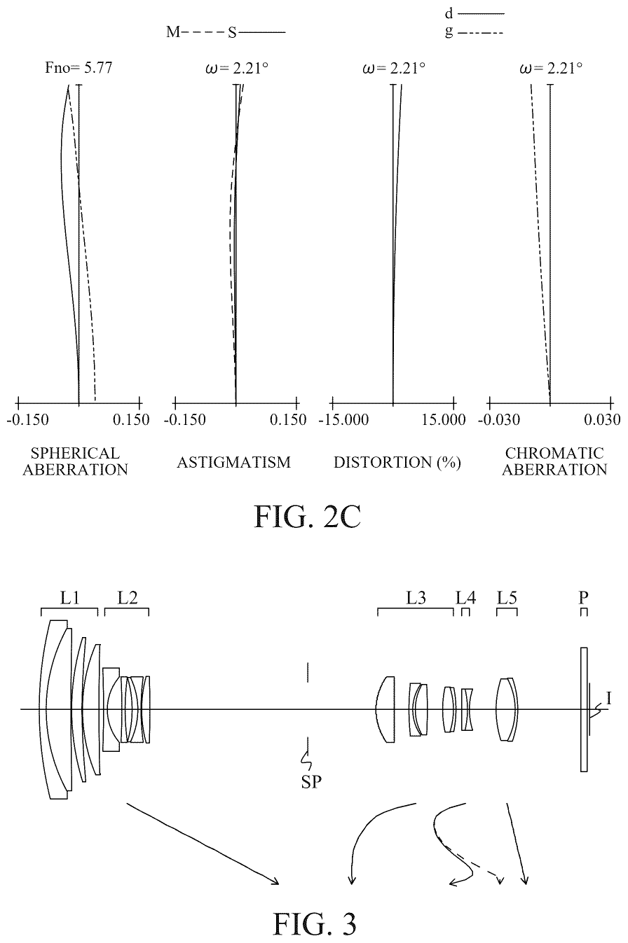

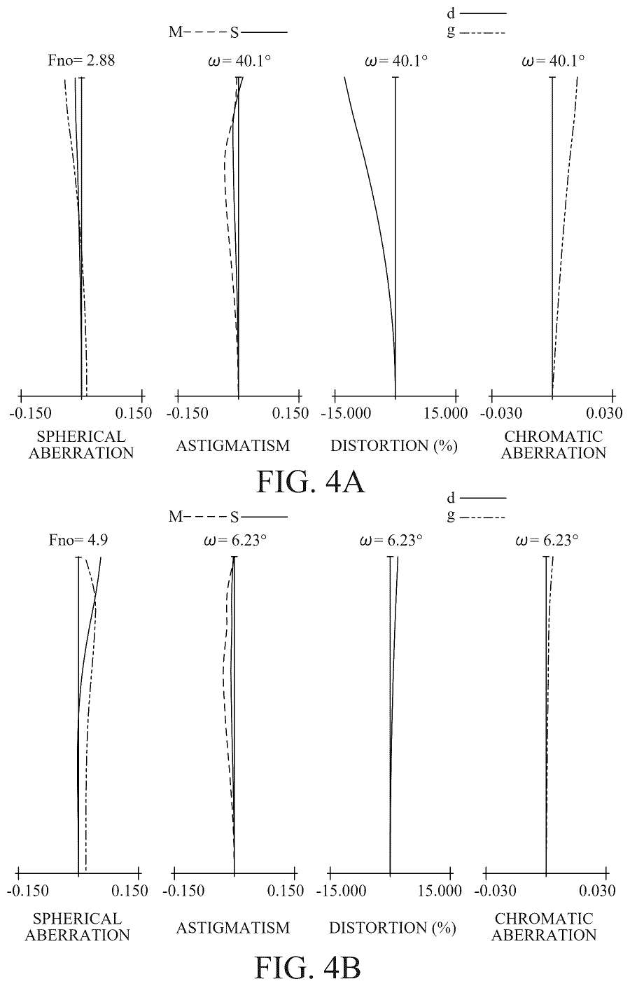

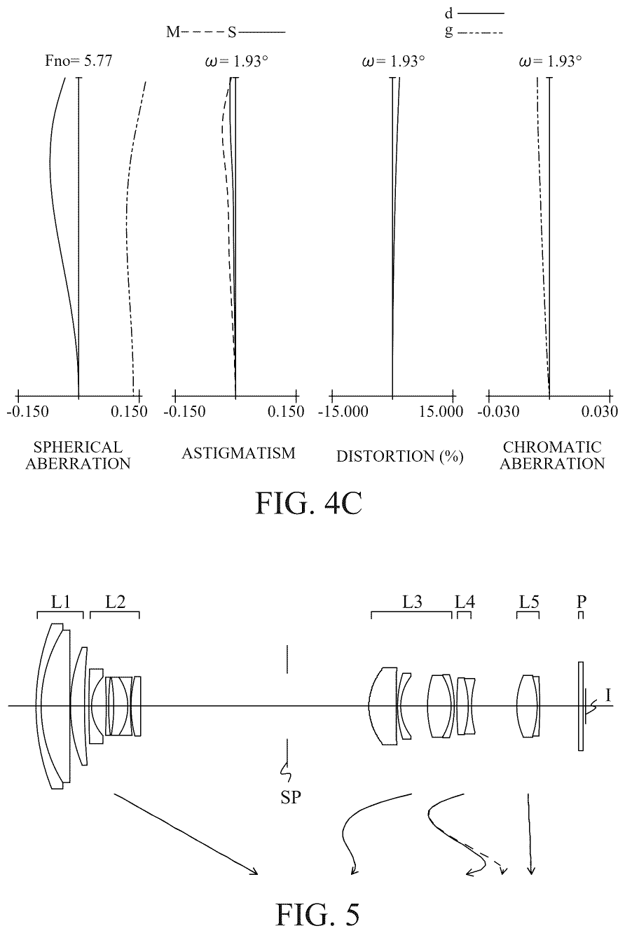

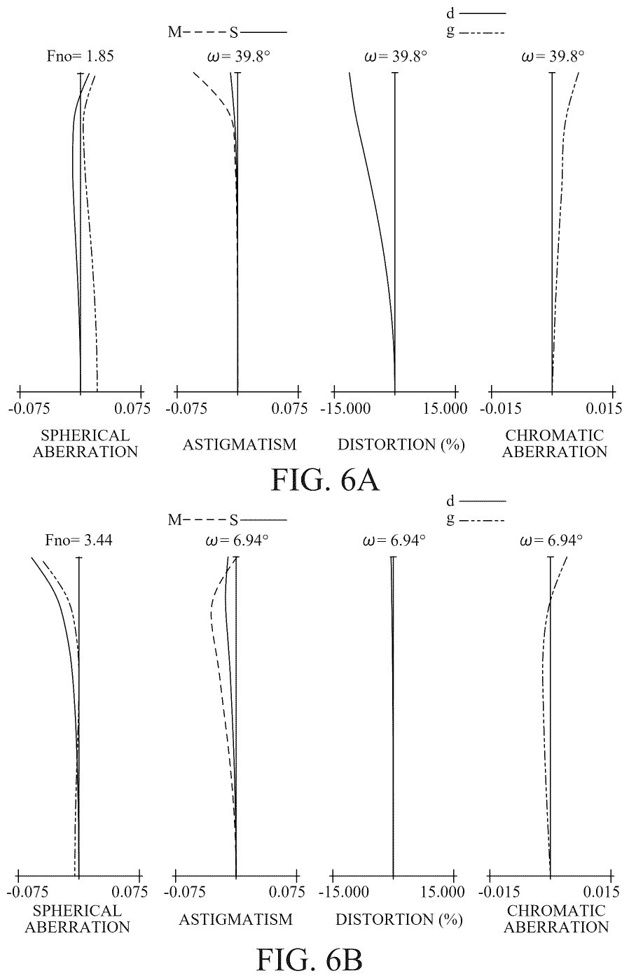

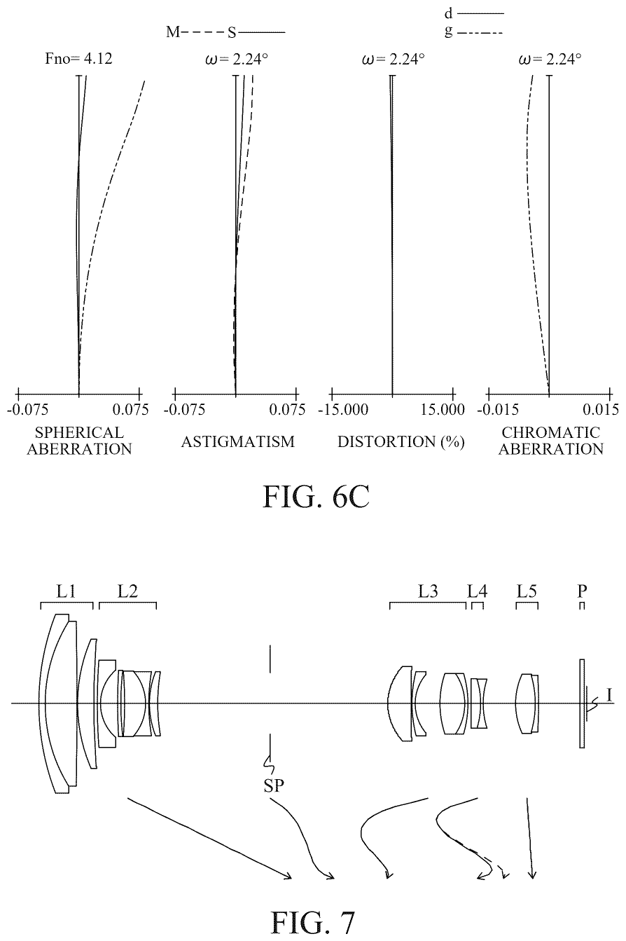

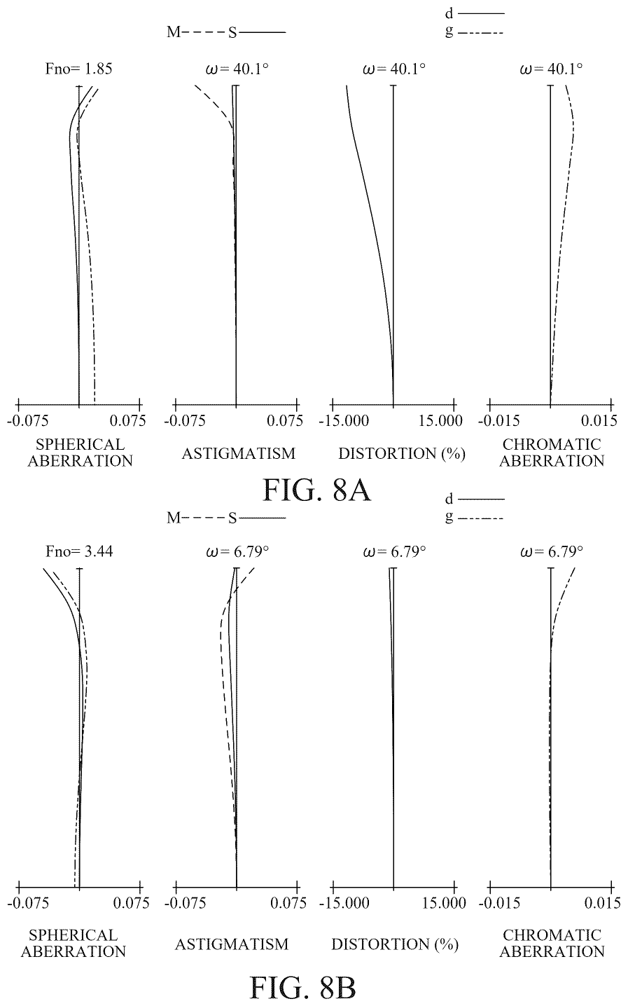

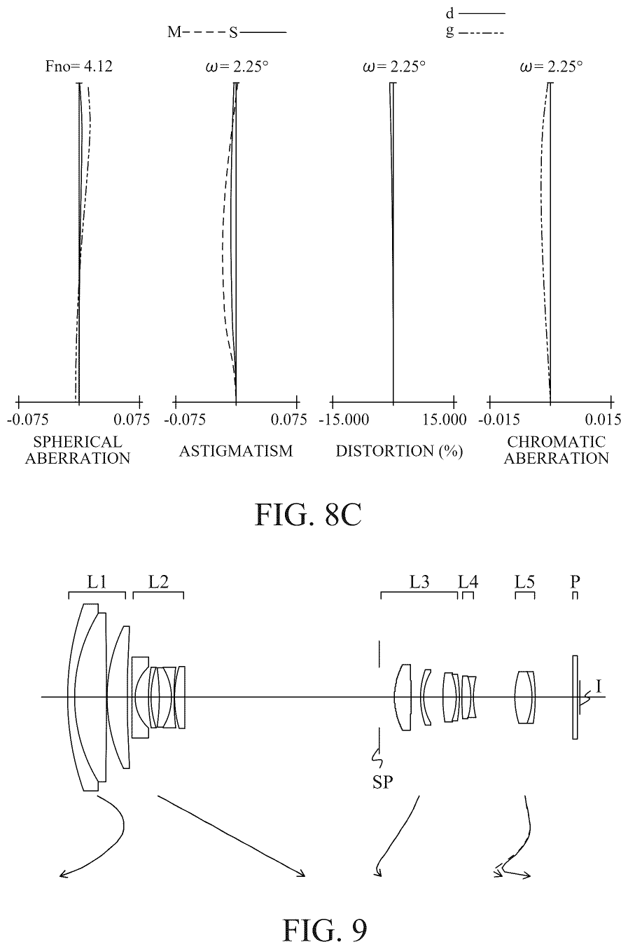

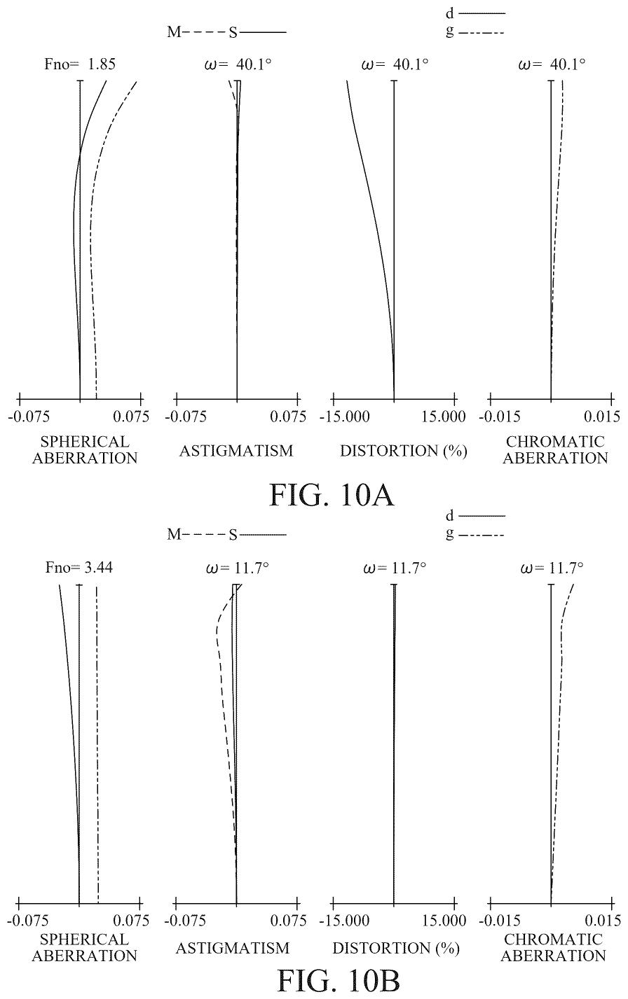

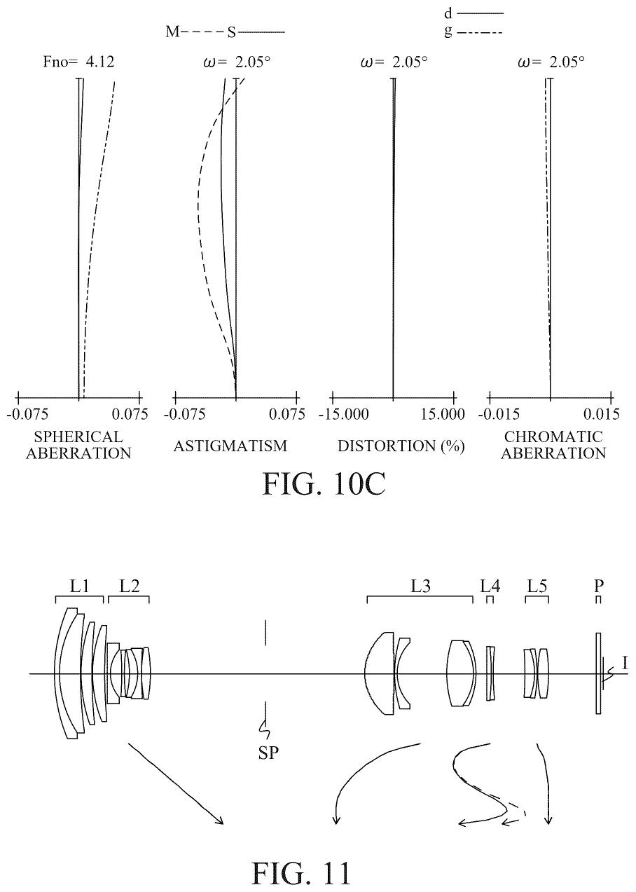

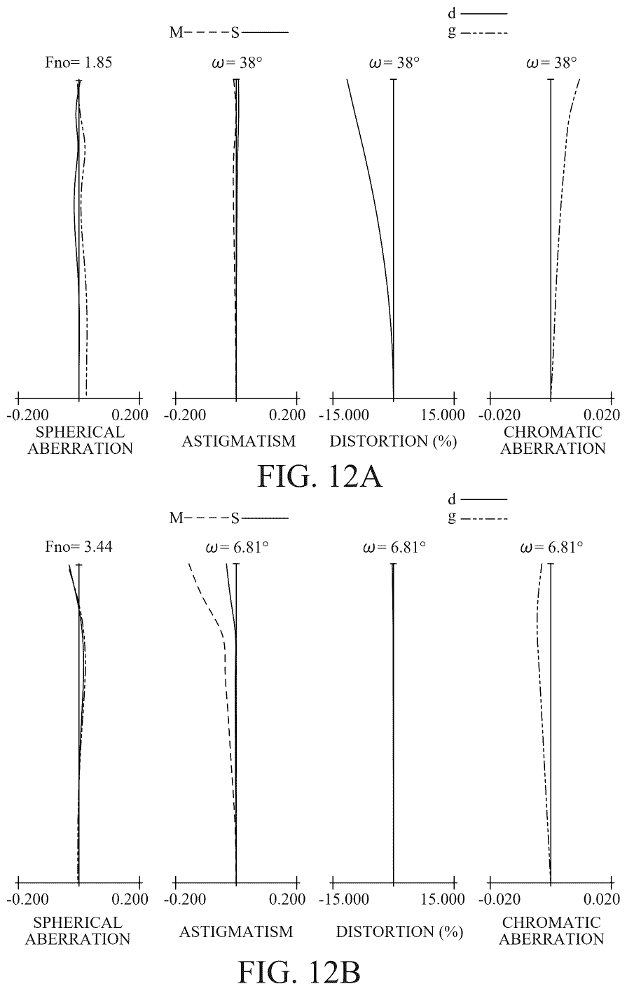

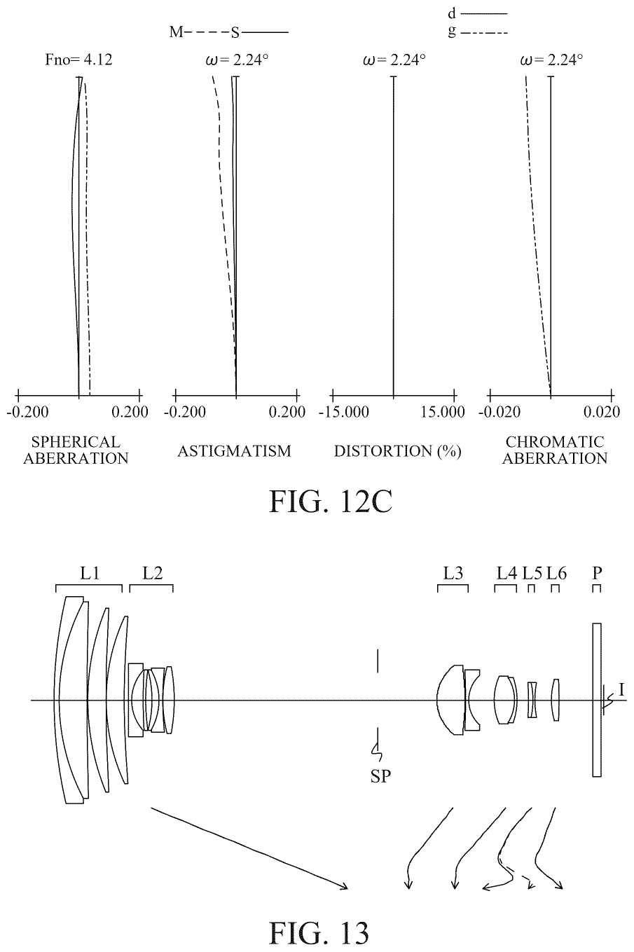

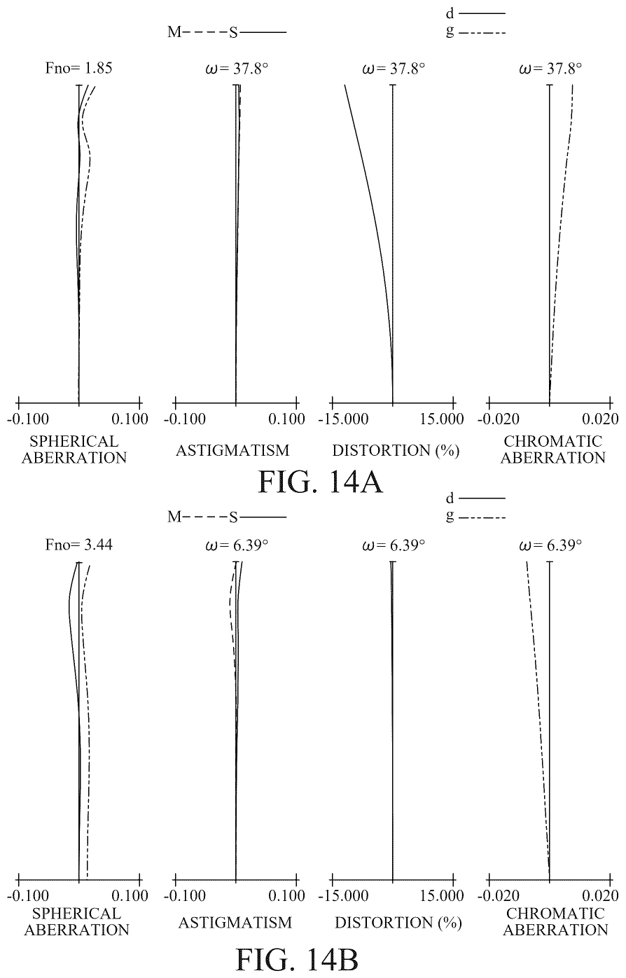

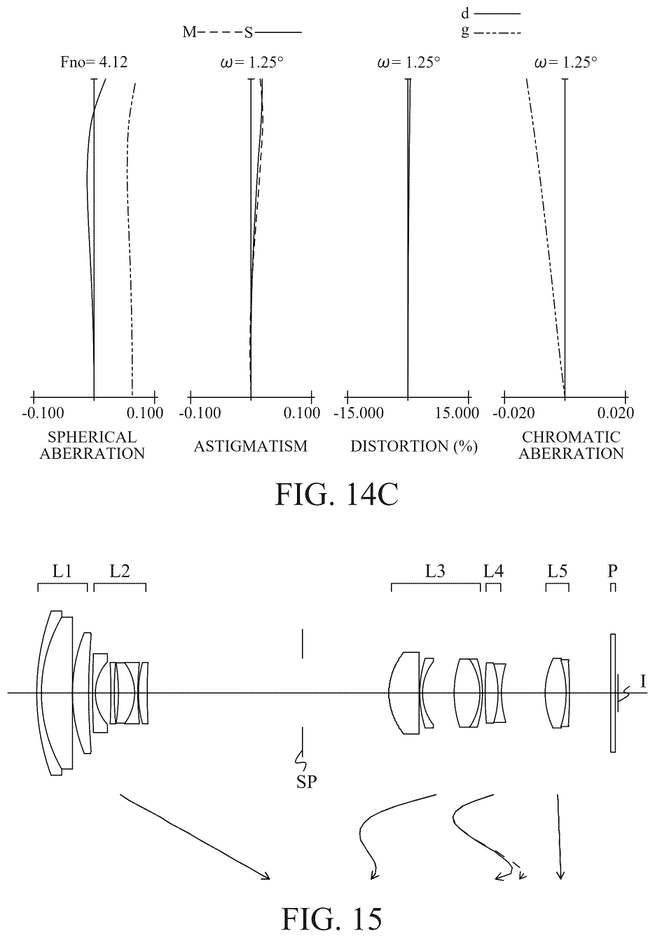

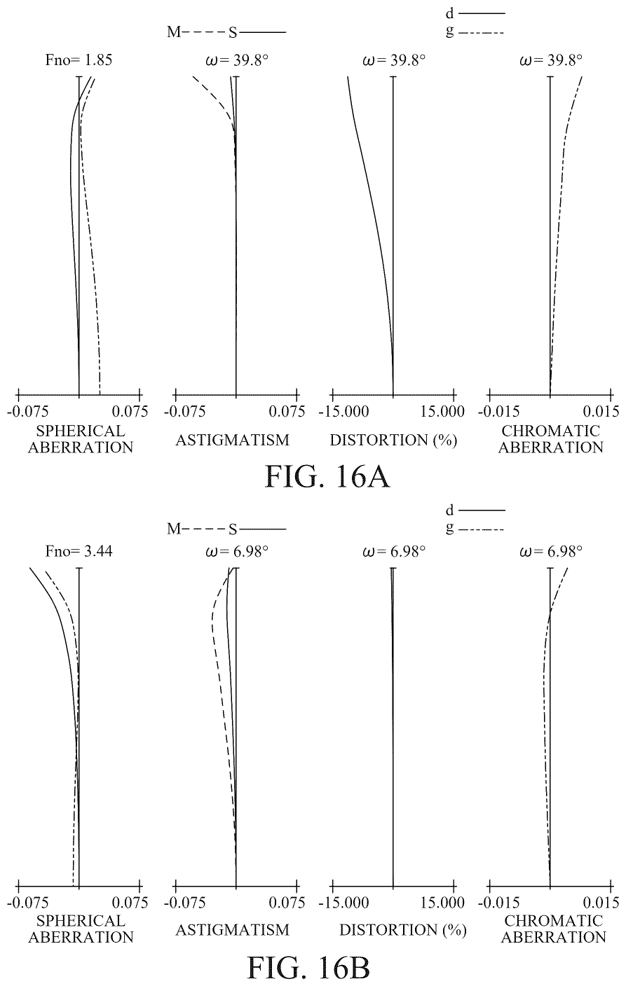

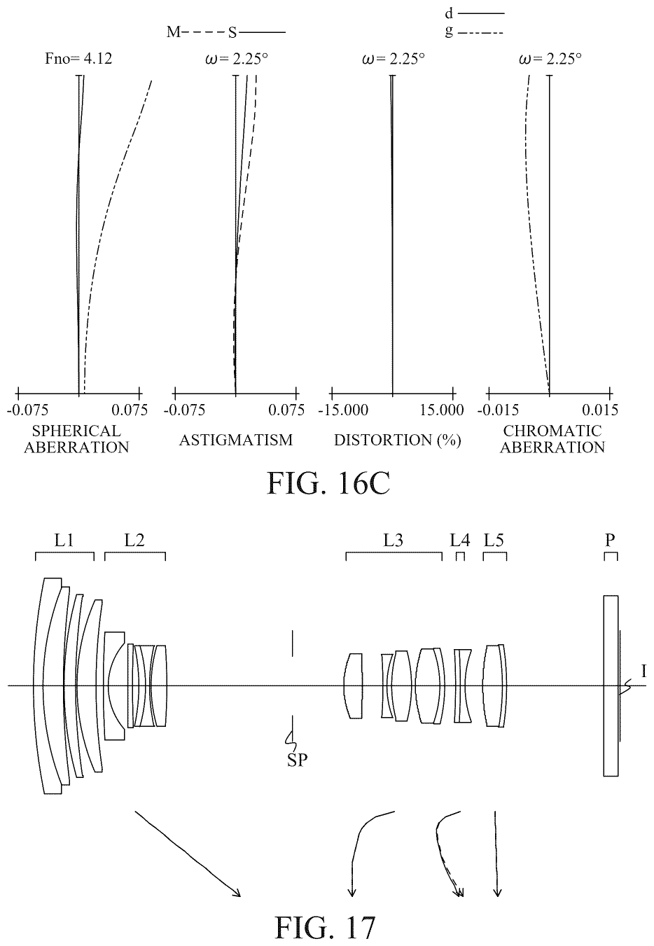

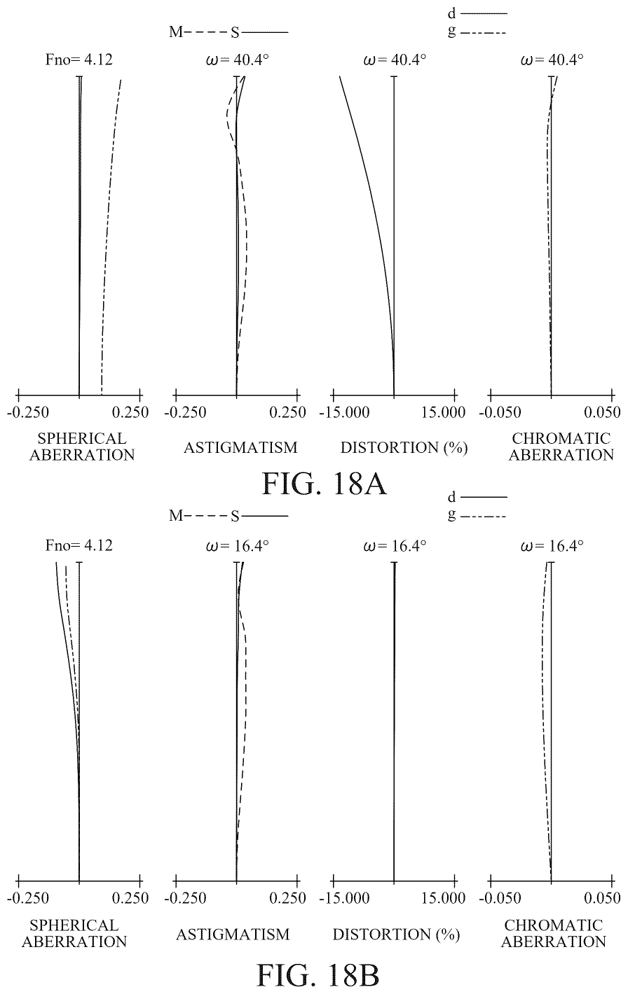

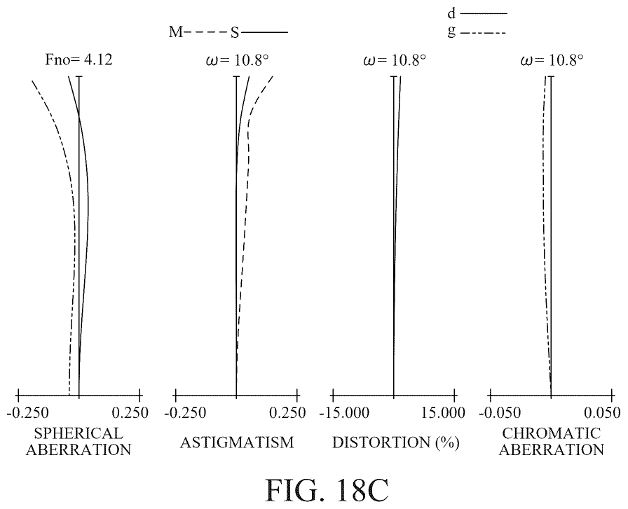

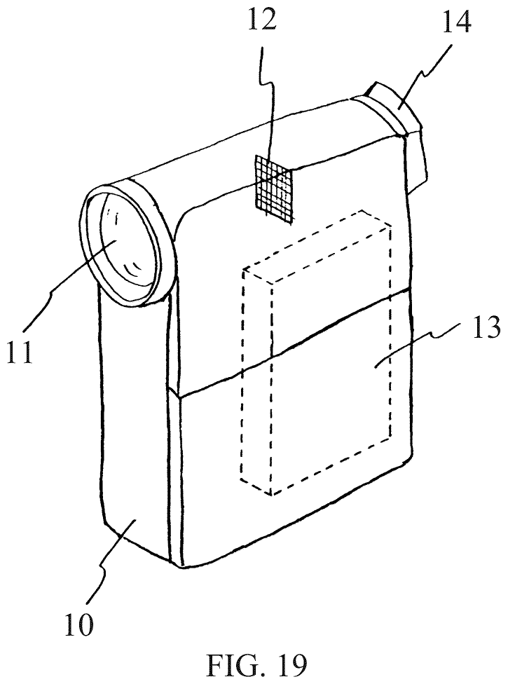

FIGS. 2, 4, 6, 8, 10, 12, 14, 16, and 18 are aberration diagrams of the zoom lenses according to Examples 1 to 9, respectively. FIGS. 2A, 4A, 6A, 8A, 10A, 12A, 14A, 16A, and 18A are the aberration diagrams of the zoom lenses according to Examples 1 to 9, respectively, at wide-angle ends. FIGS. 2B, 4B, 6B, 8B, 10B, 12B, 14B, 16B, and 18B are the aberration diagrams of the zoom lenses according to Examples 1 to 9, respectively, at intermediate zoom positions (the intermediate focal lengths). FIGS. 2C, 4C, 6C, 8C, 10C, 12C, 14C, 16C, and 18C are the aberration diagrams of the zoom lenses according to Examples 1 to 9, respectively, at telephoto ends.

In a spherical aberration diagram, Fno represents an F-number. The spherical aberration diagram illustrates a spherical aberration amount for the d-line (wavelength 587.6 nm) and g-line (wavelength 435.8 nm). In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view [°].

A description will now be given of characteristic configurations of the zoom lens according to each example.

The zoom lens according to each example may include a plurality of lens units, which include, in order from object side to image side, a first lens unit L1 with positive refractive power, a second lens unit L2 with negative refractive power, an intermediate group consisting of one or two lens units with positive refractive power, a rear unit with negative refractive power, and a final unit with positive refractive power. This configuration can provide a zoom lens that has a reduced size.

The second lens unit L2 may include five or more lenses. This configuration can suppress fluctuations in curvature of field and lateral chromatic aberration during zooming.

The zoom lens according to each example may satisfy the following inequality (1):

$$- 20. \leq M 3 / M 5 \leq - 2. \qquad ( 1 )$$

where M3 is a moving amount of the intermediate group during zooming from the wide-angle end to the telephoto end, and M5 is a moving amount of the final unit during zooming from the wide-angle end to the telephoto end.

M3 and M5 have positive signs when the lens units are disposed closer to the image plane at the telephoto end than at the wide-angle end. The absolute value of the moving amount is equal to a difference in the positions of each lens unit at the wide-angle end and the telephoto end (distance on the optical axis).

Inequality (1) defines a proper ratio between the moving amount of the intermediate group during zooming from the wide-angle end to the telephoto end and the moving amount of the final unit during zooming from the wide-angle end to the telephoto end. In a case where M3/M5 becomes lower than the lower limit of inequality (1), the diameter of the intermediate group increases. In a case where M3/M5 becomes higher than the upper limit of inequality (1), it becomes difficult to secure sufficient back focus.

The lower limit of inequality (1) may be set to −19.96, −19.92, −19.88, −19.85, −19.82, −19.79, −19.78, −19.77, −19.76, or −19.75. The upper limit of inequality (1) may be set to −2.10, −2.20, −2.30, −2.40, −2.50, −2.60, −2.70, −2.80, −2.85, or −2.90.

A description will now be given of other configurations that may be satisfied by the zoom lens according to each example.

The second lens unit L2 may include two or more positive lenses. Since the second lens unit L2 has negative refractive power, a large number of negative lenses may be used. However, in order to correct chromatic aberration, it is effective to use positive lenses made of a material with a smaller Abbe number than the negative lenses. Using two or more positive lenses increases the options for materials used for the positive lenses and makes it easier to suppress fluctuations in lateral chromatic aberration during zooming.

The intermediate group may move toward the object during zooming from the wide-angle end to the telephoto end. Thereby, a proper magnification ratio can be easily maintained and the front lens diameter is prevented from increasing.

During zooming, the first lens unit L1, which is the heaviest of the plurality of lens units, and the aperture diaphragm SP may be fixed relative to the image plane. This configuration suppresses drive noise, and restrains drive noise during magnification variation from being recorded during moving image capturing, for example.

The rear unit may be a focus lens unit that moves along the optical axis during focusing. To obtain the proper zoom ratio, the intermediate group may be disposed closer to the object at the telephoto end than at the wide-angle end, and the final unit may be disposed closer to the image plane at the telephoto end than at the wide-angle end. As a result, the distance between the intermediate group and the final unit is wider at the telephoto end. Therefore, the rear unit may be used as the focus lens unit, because it becomes easier to secure a focus stroke for focusing from infinity to a close distance, even if the refractive power of the rear unit is reduced to suppress focus changes during wobbling.

A description will now be given of inequalities that may be satisfied by the zoom lens according to each example. The zoom lens according to each example may satisfy one or more of the following inequalities (2) to (20):

$$- 6. \leq M 2 / M 3 \leq - 1.5 \qquad ( 2 )$$

$$6.5 \leq M 2 / M 5 \leq 51.3 \qquad ( 3 )$$

$$0.2 \leq d 45 w / bkw \leq 1.1 \qquad ( 4 )$$

$$2. \leq f 1 / f 3 \leq 3.7 \qquad ( 5 )$$

$$0.1 \leq f 2 / f 4 \leq 0.8 \qquad ( 6 )$$

$$- 1.5 \leq f 3 / f 4 \leq - 0.8 \qquad ( 7 )$$

$$- 3.5 \leq f 1 / f 4 \leq - 0.5 \qquad ( 8 )$$

$$1.65 \leq Nd 2 min \leq 2.15 \qquad ( 9 )$$

$$26. \leq vd 1 min \leq 45. \qquad ( 10 )$$

$$0.005 \leq d 12 w / d 12 t \leq 0.1 \qquad ( 11 )$$

$$- 0.5 \leq f 2 / fMt \leq - 0.1 \qquad ( 12 )$$

$$15. \leq ( β2 t / β2 w ) \times ( β Mt / β Mw ) \leq 35. \qquad ( 13 )$$

$$- 9. \leq f 1 / f 2 \leq - 3. \qquad ( 14 )$$

$$1.1 \leq f 1 / fMt \leq 3.7 \qquad ( 15 )$$

$$- 1.6 \leq fMt / f 4 \leq - 0.2 \qquad ( 16 )$$

$$0.3 \leq f 3 / f 5 \leq 1.5 \qquad ( 17 )$$

$$0. < \vert M 4 / M 5 \vert \leq 1.2 \qquad ( 18 )$$

$$- 1.5 \leq f 4 / f 5 \leq - 0.5 \qquad ( 19 )$$

$$2. \leq \vert M 3 / M 4 \vert \leq 40. \qquad ( 20 )$$

Here, M2 is a moving amount of the second lens unit L2 during zooming from the wide-angle end to the telephoto end. M2 has a positive sign when the lens unit is disposed closer to the image plane at the telephoto end than at the wide-angle end. The absolute value of the moving amount is equal to the difference in the positions (on-axis distance) of the second lens unit L2 at the wide-angle end and the telephoto end, d45w is an on-axis distance from the lens surface of the rear unit closest to the image plane to the lens surface of the final unit closest to the object at the wide-angle end. bkw is back focus at the wide-angle end. In a case where a glass block or the like is present in the back focus, the back focus is a value excluding the glass block. f1 is a focal length of the first lens unit L1. f2 is a focal length of the second lens unit L2. f3 is a focal length of the intermediate group. f4 is a focal length of the rear unit. Nd2 min is the lowest refractive index of the lenses included in the second lens unit L2. vd1min is the smallest Abbe number of the lenses included in the first lens unit L1. d12w is a distance on the optical axis from a lens surface closest to the image plane in the first lens unit L1 to the lens surface closest to the object in the second lens unit L2 at the wide-angle end. d12t is a distance on the optical axis from a lens surface closest to the image plane in the first lens unit L1 to a lens surface closest to the object in the second lens unit L2 at the telephoto end. fMt is a focal length of the intermediate group at the telephoto end. β2w is a lateral magnification of the second lens unit L2 at the wide-angle end. β2t is a lateral magnification of the second lens unit L2 at the telephoto end. BMw is a lateral magnification of the intermediate group at the wide-angle end. BMt is a lateral magnification of the intermediate group at the telephoto end. M4 is a moving amount of the rear unit during zooming from the wide-angle end to the telephoto end. M4 has a positive sign when the lens unit is disposed closer to the image plane at the telephoto end than at the wide-angle end. The absolute value of the moving amount is equal to the difference in position (distance on the optical axis) of the rear unit at the wide-angle end and the telephoto end. f5 is a focal length of the final unit.

Inequality (2) defines a proper ratio between the moving amount of the second lens unit L2 during zooming from the wide-angle end to the telephoto end and the moving amount of the intermediate group during zooming from the wide-angle end to the telephoto end. In a case where M2/M3 becomes lower than the lower limit of inequality (2), the overall lens length and the front lens diameter likely increase to secure the proper zoom ratio. In a case where M2/M3 becomes higher than the upper limit of inequality (2), it becomes difficult to secure the proper zoom ratio or the diameter of the intermediate group tends to increase.

Inequality (3) defines a proper ratio between the moving amount of the second lens unit L2 during zooming from the wide-angle end to the telephoto end and the moving amount of the final unit during zooming from the wide-angle end to the telephoto end. In a case where M2/M5 becomes lower than the lower limit of inequality (3), it becomes difficult to secure the proper zoom ratio or back focus. In a case where M2/M5 becomes higher than the upper limit of inequality (3), the overall lens length tends to increase.

Inequality (4) defines a proper ratio of the on-axis distance from the lens surface of the rear unit closest to the image plane to the lens surface of the final unit closest to the object at the wide-angle end to the back focus at the wide-angle end. In a case where d45w/bkw becomes lower than the lower limit of inequality (4), it becomes difficult to place the members that hold the rear unit and the final unit. In a case where d45w/bkw becomes higher than the upper limit of inequality (4), it becomes difficult to secure back focus at the telephoto end.

Inequality (5) defines a proper ratio of the focal length of the first lens unit L1 to the focal length of the intermediate group. In a case where f1/f3 becomes lower than the lower limit of inequality (5), it becomes difficult to correct spherical aberration and coma at the telephoto end. In a case where f1/f3 becomes higher than the upper limit of inequality (5), it becomes difficult to correct spherical aberration and coma at the wide-angle end.

Inequality (6) defines a proper ratio of the focal length of the second lens unit L2 to the focal length of the rear unit. In a case where f2/f4 becomes lower than the lower limit of inequality (6), it becomes difficult to suppress fluctuations in curvature of field during zooming. In a case where f2/f4 becomes higher than the upper limit of inequality (6), the overall lens length increases to secure the proper zoom ratio.

Inequality (7) defines a proper ratio between the focal length of the intermediate group and the focal length of the rear unit. In a case where f3/f4 becomes lower than the lower limit of inequality (7), it becomes difficult to correct curvature of field throughout the entire zoom range. In a case where f3/f4 becomes higher than the upper limit of inequality (7), it becomes difficult to correct spherical aberration and coma at the wide-angle end.

Inequality (8) defines a proper ratio between the focal length of the first lens unit L1 and the focal length of the rear unit. In a case where f1/f4 becomes the lower limit of inequality (8), the overall lens length increases to secure a desired zoom ratio. In a case where f1/f4 becomes higher than the upper limit of inequality (8), it becomes difficult to correct spherical aberration at the telephoto end.

Inequality (9) defines the lowest refractive index of the lenses included in the second lens unit L2. In a case where Nd2 min becomes lower than the lower limit of inequality (9), it becomes difficult to suppress an increase in the front lens diameter and suppress fluctuations in curvature of field during zooming. In a case where Nd2 min becomes higher than the upper limit of inequality (9), it becomes difficult to select materials.

Inequality (10) defines the smallest Abbe number of the lenses included in the first lens unit L1. In a case where vd1 min becomes lower than the lower limit of inequality (10), chromatic aberration at the telephoto end becomes overcorrected on a short wavelength side. In a case where vd1 min becomes higher than the upper limit of inequality (10), it becomes difficult to correct chromatic aberration at the telephoto end.

Inequality (11) defines a proper ratio of the distances on the optical axis from the lens surface of the first lens unit L1 closest to the image plane to the lens surface of the second lens unit L2 closest to the object, at the wide-angle end and the telephoto end. In a case where d12w/d12t becomes lower than the lower limit of inequality (11), the overall lens length likely increases or it becomes difficult to place the component that hold the second lens unit L2. In a case where d12w/d12t becomes higher than the upper limit of inequality (11), the front lens diameter likely increases in a wide angle-of-view scheme.

Inequality (12) defines a proper ratio between the focal length of the second lens unit L2 and the focal length of the intermediate group at the telephoto end. In a case where f2/fMt becomes lower than the lower limit of inequality (12), the overall lens length and the front lens diameter are likely to increase to secure the desired magnification ratio. In a case where f2/fMt becomes higher than the upper limit of inequality (12), it becomes difficult to correct curvature of field throughout the entire zoom range.

Inequality (13) defines a proper product of the lateral magnification ratio of the second lens unit L2 at the wide-angle end to the telephoto end and the lateral magnification ratio of the intermediate group at the wide-angle end to the telephoto end. In a case where (β2t/β2w)×(βMt/βMw) becomes lower than the lower limit of inequality (13), it becomes difficult to secure the proper zoom ratio. In a case where (β2t/β2w)×(βMt/βMw) becomes higher than the upper limit of inequality (2), it becomes difficult to correct curvature of field and coma throughout the entire zoom range.

Inequality (14) defines a proper ratio between the focal length of the first lens unit L1 and the focal length of the second lens unit L2. In a case where f1/f2 becomes lower than the lower limit of inequality (14), it becomes difficult to correct curvature of field at the wide-angle end. In a case where f1/f2 becomes higher than the upper limit of inequality (14), the overall lens length becomes too long to secure the proper zoom ratio.

Inequality (15) defines a proper ratio between the focal length of the first lens unit L1 and the focal length of the intermediate group at the telephoto end. In a case where f1/fMt becomes lower than the lower limit of inequality (15), it becomes difficult to correct spherical aberration and coma at the telephoto end. In a case where f1/fMt becomes higher than the upper limit of inequality (15), the overall lens length increases so as to secure a proper zoom ratio.

Inequality (16) defines a proper ratio between the focal length of the intermediate group and the focal length of the rear unit at the telephoto end. In a case where fMt/f4 becomes lower than the lower limit of inequality (16), it becomes difficult to correct curvature of field across the entire zoom range. In a case where fMt/f4 becomes higher than the upper limit of inequality (16), it becomes difficult to correct spherical aberration and coma at the wide-angle end.

Inequality (17) defines a proper ratio between the focal length of the intermediate group and the focal length of the final unit. In a case where f3/f5 becomes lower than the lower limit of inequality (17), it becomes difficult to correct spherical aberration and coma at the telephoto end. In a case where f3/f5 becomes higher than the upper limit of inequality (17), the overall lens length becomes long so as to secure a proper zoom ratio.

Inequality (18) defines a proper ratio between the moving amount of the rear unit during zooming from the wide-angle end to the telephoto end and the moving amount of the final unit during zooming from the wide-angle end to the telephoto end. In a case where |M4/M5| becomes higher than the upper limit of inequality (18), it becomes difficult to secure a sufficient focus stroke.

Inequality (19) defines a proper ratio between the focal length of the rear unit and the focal length of the final unit. In a case where f4/f5 becomes lower than the lower limit of inequality (19), it becomes difficult to secure a sufficient focus stroke or the overall lens length tends to become long. In a case where f4/f5 becomes higher than the upper limit of inequality (19), it becomes difficult to maintain focus changes during wobbling within the depth of focus.

Inequality (20) defines a proper ratio between the moving amount of the intermediate group during zooming from the wide-angle end to the telephoto end and the moving amount of the rear unit during zooming from the wide-angle end to the telephoto end. In a case where |M3/M4| becomes lower than the lower limit of inequality (20), it becomes difficult to secure the focus stroke or the overall lens length tends to increase. In a case where |M3/M4| becomes higher than the upper limit of inequality (20), the overall lens length tends to increase.

The lower limit of inequality (2) may be set to −5.60, −5.20, −4.80, −4.70, −4.60, −4.50, −4.40, −4.30, −4.20, or −4.10. The upper limit of inequality (2) may be set to −1.60, −1.70, −1.80, −1.90, −2.00, −2.10, −2.15, −2.20, −2.25, or −2.30.

The lower limit of inequality (3) may be set to 6.60, 6.70, 6.80, 6.90, 6.95, 7.00, 7.05, 7.10, 7.15, or 7.20. The upper limit of inequality (3) may be set to 51.0, 50.0, 49.0, 48.0, 47.6, 47.3, 47.0, 46.9, 46.8, or 46.7.

The lower limit of inequality (4) may be set to 0.205, 0.210, 0.215, 0.220, 0.225, 0.227, 0.229, 0.231, 0.233, or 0.235. The upper limit of inequality (4) may be set to 1.050, 1.030, 1.010, 1.000, 0.990, 0.980, 0.975, 0.970, 0.965, or 0.960.

The lower limit of inequality (5) may be set to 2.05, 2.10, 2.15, 2.20, 2.25, or 2.27. The upper limit of inequality (5) may be set to 3.65, 3.60, 3.55, 3.50, 3.45, 3.43, 3.41, 3.39, 3.37, or 3.35.

The lower limit of inequality (6) may be set to 0.101, 0.102, 0.103, 0.104, 0.105, 0.106, or 0.107. The upper limit of inequality (6) may be set to 0.75, 0.70, 0.66, 0.64, 0.62, 0.60, 0.58, 0.56, 0.54, or 0.51.

The lower limit of inequality (7) may be set to −1.45, −1.40, −1.35, −1.30, −1.25, −1.20, −1.18, −1.17, −1.16, or −1.15. The upper limit of inequality (7) may be set to −0.810, −0.820, −0.830, −0.840, −0.845, −0.850, −0.855, −0.860, −0.865, or −0.870.

The lower limit of inequality (8) may be set to −3.45, −3.40, −3.35, −3.30, −3.25, −3.20, −3.16, −3.14, −3.12, or −3.10. The upper limit of inequality (8) may beset to −0.51, −0.52, −0.53, −0.54, −0.55, −0.56, −0.57, −0.58, or −0.59.

The lower limit of inequality (9) may be set to 1.660, 1.665, 1.670, 1.675, 1.680, 1.685, 1.690, 1.694, or 1.696. The upper limit of inequality (9) may be set to 2.10, 2.05, 2.00, 1.98, 1.97, 1.96, 1.95, 1.94, 1.93, or 1.92.

The lower limit of inequality (10) may be set to 26.3, 26.6, 26.9, 27.2, 27.5, 27.8, 28.1, 28.3, 28.4, or 28.5. The upper limit of inequality (10) may be set to 44.5, 44.0, 43.5, 43.0, 42.5, 42.2, 41.9, 41.6, 41.3, or 41.0.

The lower limit of inequality (11) may be set to 0.007, 0.009, 0.010, 0.011, 0.012, 0.014, 0.016, 0.018, 0.019, or 0.020. The upper limit value of inequality (11) may be set to 0.090, 0.080, 0.070, 0.060, 0.050, 0.045, 0.040, 0.035, 0.031, or 0.029.

The lower limit value of inequality (12) may be set to −0.498, −0.496, −0.494, −0.492, −0.491, −0.490, −0.489, −0.488, −0.487, or −0.486. The upper limit of inequality (12) may be set to −0.120, −0.140, −0.160, −0.180, −1.190, −0.200, −0.210, −0.220, −0.230, or −0.240.

The lower limit of inequality (13) may be set to 15.2, 15.4, 15.6, 15.8, 16.0, 16.2, 16.4, 16.6, 16.8, or 17.0. The upper limit of inequality (13) may be set to 34.0, 33.0, 32.0, 31.0, 30.0, 29.0, 28.5, 28.0, 27.5, or 27.0.

The lower limit of inequality (14) may be set to −6.95, −6.90, −6.85, −6.80, −6.75, −6.70, −6.65, −6.62, −6.60, or −6.58. The upper limit of inequality (14) may be set to −4.60, −4.70, −4.80, −4.90, −5.00, −5.10, −5.20, −5.25, −5.30, or −5.32.

The lower limit of inequality (15) may be set to 1.15, 1.18, 1.20, 1.22, 1.24, 1.26, 1.28, 1.30, 1.32, or 1.34. The upper limit of inequality (15) may be set to 3.65, 3.60, 3.55, 3.50, 3.45, 3.40, 3.35, 3.30, 3.25, or 3.20.

The lower limit of inequality (16) may be set to −1.55, −1.50, −1.45, −1.40, −1.35, −1.30, −1.25, −1.20, or −1.15. The upper limit of inequality (16) may be set to −0.23, −0.26, −0.29, −0.31, −0.33, −0.35, −0.37, −0.39, −0.41, or −0.43.

The lower limit of inequality (17) may be set to 0.32, 0.34, 0.36, 0.37, 0.38, 0.39, 0.40, 0.41, 0.42, or 0.43. The upper limit of inequality (17) may be set to 1.45, 1.40, 1.35, 1.30, 1.25, 1.20, 1.16, 1.14, 1.12, or 1.10.

The upper limit of inequality (18) may be set to 1.16, 1.12, 1.08, 1.04, 1.00, 0.96, 0.92, 0.90, 0.89, or 0.88.

The lower limit of inequality (19) may be set to −1.45, −1.40, −1.35, −1.30, −1.25, −1.20, −1.16, −1.14, −1.12, or −1.10. The upper limit of inequality (19) may be set to −0.55, −0.60, −0.65, −0.70, −0.75, −0.78, −0.80, −0.82, −0.84, or −0.86.

The lower limit of inequality (20) may be set to 2.2, 2.4, 2.6, 2.7, 2.8, 2.9, 3.0, 3.1, 3.2, or 3.3. The upper limit of inequality (20) may be set to 39.0, 38.0, 37.5, 37.0, 36.5, 36.0, 35.5, 35.0, 34.5, or 34.0.

Next, the zoom lens according to each example will be described in detail.

In Examples 1 to 4, 8, and 9, during zooming, the first lens unit L1 is fixed relative to the image plane, and the second lens unit L2, third lens unit L3, fourth lens unit L4, and fifth lens unit L5 move along the optical axis. During focusing, the fourth lens unit L4 moves along the optical axis. Image stabilization can be performed by moving the whole or part of the third lens unit L3 in a direction with a component orthogonal to the optical axis.

In Example 5, during zooming, the first lens unit L1, the second lens unit L2, the third lens unit L3, and the fifth lens unit L5 move along the optical axis, while the fourth lens unit L4 is fixed relative to the image plane. During focusing, the fifth lens unit L5 moves along the optical axis. Image stabilization can be performed by moving the whole or part of the third lens unit L3, or the entire fourth lens unit L4 in a direction with a component orthogonal to the optical axis.

In Examples 1 to 5, 8, and 9, the third lens unit L3 corresponds to the intermediate group, the fourth lens unit L4 corresponds to the rear unit, and the fifth lens unit L5 corresponds to the final unit.

The zoom lens according to Example 6 includes a plurality of lens units, which include, in order from the object side to the image side, the first lens unit L1, the second lens unit L2, the third lens unit L3, the fourth lens unit L4, and the fifth lens unit L5 having positive, negative, positive, negative, and positive refractive powers. In Example 6, the third lens unit L3 corresponds to the intermediate group, the fourth lens unit L4 corresponds to the rear unit, and the fifth lens unit L5 corresponds to the final unit. During zooming, the first lens unit L1 is fixed relative to the image plane, while the second lens unit L2, the third lens unit L3, the fourth lens unit L4, and the fifth lens unit L5 move along the optical axis. Image stabilization can be performed by moving the whole or part of the third lens unit L3 in a direction with a component orthogonal to the optical axis.

The plurality of lens units in the zoom lens according to Example 7 include, in order from the object side to the image side, the first lens unit L1, the second lens unit L2, the third lens unit L3, the fourth lens unit L4, the fifth lens unit L5, and the sixth lens unit L6, with positive, negative, positive, positive, negative, and positive refractive powers. In Example 7, the third lens unit L3 and the fourth lens unit L4 correspond to the intermediate group, the fifth lens unit L5 corresponds to the rear unit, and the sixth lens unit L6 corresponds to the final unit. During zooming, the first lens unit L1 is fixed relative to the image plane, while the second lens unit L2, the third lens unit L3, the fourth lens unit L4, the fifth lens unit L5, and the sixth lens unit L6 move along the optical axis. Image stabilization can be performed by moving the whole or part of the third lens unit L3, or the entire fourth lens unit L4 in a direction with a component perpendicular to the optical axis.

In each example, the second lens unit L2 consists of, in order from the object side to the image side, a negative lens, a negative lens, a cemented lens of a positive lens and a negative lens, and a positive lens.

Numerical examples 1 to 9 corresponding to Examples 1 to 9, respectively, will be illustrated below.

In the surface data for each numerical example, r represents a radius of curvature of each optical surface, and d (mm) represents an on-axis distance (distance on the optical axis) between m-th and (m+1)-th surfaces, where m is a surface number counted from the light incident side. nd represents a refractive index of each optical element for the d-line, and vd represents the Abbe number of each optical element based on the d-line. The Abbe number vd of a material is expressed as follows:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer line.

In each numerical example, d, focal length (mm), F-number, and half angle of view [°] are all values when the zoom lens in each example is in an in-focus state on an object at infinity. A half angle of view is a value determined by ray tracing. The “overall lens length” is a distance on the optical axis from the lens surface with optical power closest to the object to the paraxial image plane, expressed as the air-equivalent length (the length when optical block G is not included). “BF” represents the back focus, and is expressed as a distance on the optical axis from the lens surface with optical power closest to the image plane to the paraxial image plane, expressed as the air-equivalent length.

In a case where the optical surface is aspherical, an asterisk * is added to the right of the surface number. The aspheric shape is expressed as follows:

$$X = \frac{( 1 / R ) {h}^{2}}{1 + \sqrt{1 - ( 1 + k ) {( h / R )}^{2}}} + A 4 {h}^{4} + A 6 {h}^{6} + A 8 {h}^{8} + A 10 {h}^{10}$$

where X is a displacement amount from a surface vertex in the optical axis direction, h is a height from the optical axis in the direction perpendicular to the optical axis, R is a paraxial radius of curvature, k is a conic constant, and A4, A6, A8, and A10 are aspheric coefficients of respective orders.

“e±XX” in each aspheric coefficient means “×10^{±XX}.” WIDE represents a wide-angle end, MIDDLE represents an intermediate zoom position, and TELE represents a telephoto end.

NUMERICAL EXAMPLE 1
UNIT: mm
SURFACE DATA

| Surface No. | r | d | nd | νd |
|---|---|---|---|---|
| 1 | 309.071 | 1.75 | 1.85150 | 40.8 |
| 2 | 45.294 | 6.82 | 1.49700 | 81.5 |
| 3 | −257.207 | 0.15 | | |
| 4 | 66.298 | 3.13 | 1.49700 | 81.5 |
| 5 | 594.924 | 0.13 | | |
| 6 | 43.810 | 4.05 | 1.59522 | 67.7 |
| 7 | 827.908 | (Variable) | | |
| 8 | −293.352 | 0.85 | 1.89190 | 37.1 |
| 9 | 13.328 | 3.03 | | |
| 10 | 156.589 | 0.70 | 2.05090 | 26.9 |
| 11 | 29.902 | 3.01 | | |
| 12 | −21.463 | 1.75 | 1.85478 | 24.8 |
| 13 | −14.611 | 0.70 | 1.72916 | 54.7 |
| 14 | 10250.684 | 0.11 | | |
| 15 | 48.072 | 2.49 | 1.89286 | 20.4 |
| 16 | −58.604 | (Variable) | | |
| 17 (SP) | ∞ | (Variable) | | |
| 18* | 17.225 | 4.55 | 1.58313 | 59.4 |
| 19* | −59.610 | 5.35 | | |
| 20 | 25.947 | 0.70 | 1.96300 | 24.1 |
| 21 | 15.035 | 4.76 | | |
| 22 | 23.907 | 4.04 | 1.49700 | 81.5 |
| 23 | −13.597 | 0.70 | 1.90525 | 35.0 |
| 24 | −22.045 | (Variable) | | |
| 25 | 329.166 | 1.40 | 1.89286 | 20.4 |
| 26 | −32.452 | 0.60 | 1.83481 | 42.7 |
| 27 | 16.723 | (Variable) | | |
| 28 | 72.392 | 4.75 | 1.51742 | 52.4 |
| 29 | −12.353 | 0.70 | 2.05090 | 26.9 |
| 30 | −26.471 | 1.70 | | |
| 31 | −70.539 | 2.83 | 1.62004 | 36.3 |
| 32 | −18.298 | (Variable) | | |
| 33 | ∞ | 1.93 | 1.51633 | 64.1 |
| 34 | ∞ | 1.00 | | |
| Image Plane | ∞ | | | |

ASPHERIC DATA
18th Surface
K = 0.00000e+00 A 4 = −1.66504e−05 A 6 = −2.89555e−08
A 8 = 1.24059e−10 A10 = −8.64505e−13
19th Surface
K = 0.00000e+00 A 4 = 2.09321e−05 A 6 = −4.11374e−08
A 8 = 2.65954e−10 A10 = −8.83687e−13

VARIOUS DATA

| | |
|---|---|
| ZOOM RATIO | 21.55 |

| | WIDE | MIDDLE | TELE |
|---|---|---|---|
| Focal Length | 8.30 | 60.16 | 178.89 |
| Fno | 2.88 | 4.90 | 5.77 |
| Half Angle of View[°] | 40.48 | 6.51 | 2.21 |
| Image Height | 6.25 | 7.05 | 7.05 |
| Overall Lens Length | 146.29 | 146.29 | 146.29 |
| BF | 19.54 | 14.22 | 14.04 |
| d7 | 1.07 | 29.02 | 41.00 |
| d16 | 41.60 | 13.65 | 1.67 |
| d17 | 16.94 | 0.96 | 0.90 |
| d24 | 1.80 | 16.54 | 13.03 |
| d27 | 4.61 | 11.17 | 14.91 |
| d32 | 17.27 | 11.94 | 11.77 |

ZOOM LENS UNIT DATA

| Lens Unit | Starting Surface | Focal Length |
|---|---|---|
| 1 | 1 | 59.64 |
| 2 | 8 | −11.15 |
| 4 | 18 | 24.18 |
| 5 | 25 | −22.10 |
| 6 | 28 | 34.33 |

NUMERICAL EXAMPLE 2
UNIT: mm
SURFACE DATA

| Surface No. | r | d | nd | νd |
|---|---|---|---|---|
| 1 | 97.607 | 1.89 | 1.89190 | 37.1 |
| 2 | 45.764 | 6.68 | 1.49700 | 81.5 |
| 3 | 1545.305 | 0.17 | | |
| 4 | 65.113 | 2.89 | 1.49700 | 81.5 |
| 5 | 203.279 | 0.17 | | |
| 6 | 44.761 | 4.47 | 1.49700 | 81.5 |
| 7 | 732.754 | (Variable) | | |
| 8 | −222.514 | 0.92 | 1.89190 | 37.1 |
| 9 | 13.464 | 4.12 | | |
| 10 | −148.355 | 0.73 | 1.89190 | 37.1 |
| 11 | 63.470 | 2.05 | | |
| 12 | −30.371 | 1.56 | 1.89286 | 20.4 |
| 13 | −19.848 | 0.74 | 1.69680 | 55.5 |
| 14 | 64.516 | 0.17 | | |
| 15 | 33.680 | 2.30 | 1.89286 | 20.4 |
| 16 | −365.582 | (Variable) | | |
| 17 (SP) | ∞ | (Variable) | | |
| 18* | 14.774 | 5.02 | 1.58313 | 59.4 |
| 19* | −175.511 | 3.90 | | |
| 20 | 61.390 | 1.07 | 1.89190 | 37.1 |
| 21 | 11.942 | 0.69 | | |
| 22 | 13.683 | 3.38 | 1.51633 | 64.1 |
| 23 | −125.765 | 4.05 | | |
| 24 | 28.191 | 3.02 | 1.48749 | 70.2 |
| 25 | −19.276 | 0.60 | 2.00100 | 29.1 |
| 26 | −29.914 | (Variable) | | |
| 27 | 1127.760 | 1.55 | 1.95906 | 17.5 |
| 28 | −24.565 | 0.60 | 1.90366 | 31.3 |
| 29 | 17.931 | (Variable) | | |
| 30 | 26.854 | 5.11 | 1.48749 | 70.2 |
| 31 | −17.721 | 0.72 | 1.90366 | 31.3 |
| 32 | −25.908 | (Variable) | | |
| 33 | ∞ | 1.84 | 1.51633 | 64.1 |
| 34 | ∞ | 1.00 | | |
| Image Plane | ∞ | | | |

ASPHERIC DATA
18th Surface
K = 0.00000e+00 A 4 = −1.36811e−05
19th Surface
K = 0.00000e+00 A 4 = 2.07566e−05 A 6 = 3.65077e−08

VARIOUS DATA

| | |
|---|---|
| ZOOM RATIO | 24.59 |

| | WIDE | MIDDLE | TELE |
|---|---|---|---|
| Focal Length | 8.34 | 63.32 | 205.12 |
| Fno | 2.88 | 4.90 | 5.77 |
| Half Angle of View[°] | 40.08 | 6.23 | 1.93 |
| Image Height | 6.13 | 7.05 | 7.05 |
| Overall Lens Length | 149.51 | 149.51 | 149.51 |
| BF | 19.28 | 15.67 | 14.12 |
| d7 | 1.21 | 30.12 | 42.51 |
| d16 | 43.02 | 14.10 | 1.71 |
| d17 | 18.53 | 1.25 | 1.10 |
| d26 | 1.61 | 17.56 | 14.65 |
| d29 | 7.30 | 12.25 | 16.86 |
| d32 | 17.07 | 13.46 | 11.90 |

ZOOM LENS UNIT DATA

| Lens Unit | Starting Surface | Focal Length |
|---|---|---|
| 1 | 1 | 64.10 |
| 2 | 8 | −10.69 |
| 4 | 18 | 24.28 |
| 5 | 27 | −21.18 |
| 6 | 30 | 34.62 |

NUMERICAL EXAMPLE 3
UNIT: mm
SURFACE DATA

| Surface No. | r | d | nd | νd |
|---|---|---|---|---|
| 1 | 39.929 | 0.84 | 2.00480 | 29.0 |
| 2 | 25.787 | 5.19 | 1.59522 | 67.7 |
| 3 | 862.615 | 0.11 | | |
| 4 | 27.285 | 2.61 | 1.59522 | 67.7 |
| 5 | 110.003 | (Variable) | | |
| 6 | 164.147 | 0.46 | 2.05090 | 26.9 |
| 7 | 7.773 | 2.67 | | |
| 8 | −268.311 | 0.55 | 2.05090 | 26.9 |
| 9 | 47.204 | 0.87 | | |
| 10 | −29.366 | 2.49 | 1.92286 | 18.9 |
| 11 | −9.058 | 0.55 | 1.90525 | 35.0 |
| 12 | 45.873 | 0.11 | | |
| 13 | 20.840 | 1.71 | 1.92286 | 18.9 |
| 14 | −244.990 | (Variable) | | |
| 15 (SP) | ∞ | (Variable) | | |
| 16* | 10.166 | 4.89 | 1.76802 | 49.2 |
| 17* | 685.546 | 0.24 | | |
| 18 | 19.007 | 0.56 | 2.00100 | 29.1 |
| 19 | 8.607 | 4.92 | | |
| 20 | 18.013 | 4.27 | 1.62280 | 57.0 |
| 21 | −10.562 | 0.53 | 2.05090 | 26.9 |
| 22 | −19.017 | (Variable) | | |
| 23 | 62.906 | 2.08 | 1.95906 | 17.5 |
| 24 | −17.033 | 0.52 | 2.05090 | 26.9 |
| 25 | 17.406 | (Variable) | | |
| 26 | 13.496 | 3.71 | 1.77250 | 49.6 |
| 27 | −17.539 | 0.55 | 1.92286 | 18.9 |
| 28 | −84.085 | (Variable) | | |
| 29 | ∞ | 0.88 | 1.51633 | 64.1 |
| 30 | ∞ | 1.00 | | |
| Image Plane | ∞ | | | |

ASPHERIC DATA
16th Surface
K = −2.76224e−01 A 4 = −2.34922e−05
17th Surface
K = 0.00000e+00 A 4 = 4.86811e−05

VARIOUS DATA

| | |
|---|---|
| ZOOM RATIO | 21.63 |

| | WIDE | MIDDLE | TELE |
|---|---|---|---|
| Focal Length | 3.81 | 26.40 | 82.34 |
| Fno | 1.85 | 3.44 | 4.12 |
| Half Angle of View[°] | 39.83 | 6.94 | 2.24 |
| Image Height | 2.82 | 3.20 | 3.20 |
| Overall Lens Length | 99.73 | 99.73 | 99.73 |
| BF | 8.54 | 8.16 | 7.99 |
| d5 | 0.74 | 18.78 | 26.51 |
| d14 | 26.55 | 8.51 | 0.78 |
| d15 | 14.79 | 3.49 | 3.88 |
| d22 | 0.49 | 13.09 | 11.78 |
| d25 | 8.19 | 7.28 | 8.35 |
| d28 | 6.96 | 6.58 | 6.41 |

ZOOM LENS UNIT DATA

| Lens Unit | Starting Surface | Focal Length |
|---|---|---|
| 1 | 1 | 40.39 |
| 2 | 6 | −6.48 |
| 4 | 16 | 17.77 |
| 5 | 23 | −20.28 |
| 6 | 26 | 16.89 |

NUMERICAL EXAMPLE 4
UNIT: mm
SURFACE DATA

| Surface No. | r | d | nd | νd |
|---|---|---|---|---|
| 1 | 43.948 | 1.10 | 1.95375 | 32.3 |
| 2 | 27.892 | 5.74 | 1.49700 | 81.5 |
| 3 | −1562.702 | 0.11 | | |
| 4 | 28.777 | 3.02 | 1.59522 | 67.7 |
| 5 | 147.462 | (Variable) | | |
| 6 | 111.289 | 0.58 | 2.05090 | 26.9 |
| 7 | 8.104 | 3.06 | | |
| 8 | 104.748 | 0.57 | 2.05090 | 26.9 |
| 9 | 50.778 | 0.66 | | |
| 10 | −74.218 | 3.83 | 1.92286 | 18.9 |
| 11 | −8.715 | 0.57 | 1.91650 | 31.6 |
| 12 | 34.155 | 0.11 | | |
| 13 | 15.560 | 1.50 | 1.92286 | 18.9 |
| 14 | 33.405 | (Variable) | | |
| 15 (SP) | ∞ | (Variable) | | |
| 16* | 9.301 | 4.30 | 1.76802 | 49.2 |
| 17* | −301.531 | 0.14 | | |
| 18 | 23.002 | 0.57 | 1.95375 | 32.3 |
| 19 | 8.076 | 4.47 | | |
| 20 | 16.991 | 4.50 | 1.69680 | 55.5 |
| 21 | −9.671 | 0.57 | 2.05090 | 26.9 |
| 22 | −19.365 | (Variable) | | |
| 23 | −451.387 | 1.62 | 1.95906 | 17.5 |
| 24 | −15.277 | 0.55 | 1.91650 | 31.6 |
| 25 | 14.608 | (Variable) | | |
| 26 | 12.495 | 3.60 | 1.77250 | 49.6 |
| 27 | −17.926 | 0.57 | 1.92286 | 18.9 |
| 28 | −142.527 | (Variable) | | |
| 29 | ∞ | 0.88 | 1.51633 | 64.1 |
| 30 | ∞ | 1.00 | | |
| Image Plane | ∞ | | | |

ASPHERIC DATA
16th Surface
K = −2.31862e−01 A 4 = −3.38139e−05
17th Surface
K = 0.00000e+00 A 4 = 7.22194e−05

VARIOUS DATA

| | |
|---|---|
| ZOOM RATIO | 21.65 |

| | WIDE | MIDDLE | TELE |
|---|---|---|---|
| Focal Length | 3.80 | 27.19 | 82.22 |
| Fno | 1.85 | 3.44 | 4.12 |
| Half Angle of View[°] | 40.09 | 6.79 | 2.25 |
| Image Height | 2.82 | 3.20 | 3.20 |
| Overall Lens Length | 99.61 | 99.61 | 99.61 |
| BF | 9.04 | 8.34 | 8.04 |
| d5 | 0.65 | 21.43 | 30.33 |
| d14 | 20.47 | 6.90 | 2.27 |
| d15 | 21.27 | 4.34 | 2.38 |
| d22 | 0.62 | 10.18 | 8.03 |
| d25 | 5.82 | 6.67 | 6.82 |
| d28 | 7.46 | 6.76 | 6.46 |

ZOOM LENS UNIT DATA

| Lens Unit | Starting Surface | Focal Length |
|---|---|---|
| 1 | 1 | 45.23 |
| 2 | 6 | −6.92 |
| 4 | 16 | 16.13 |
| 5 | 23 | −16.08 |
| 6 | 26 | 16.65 |

NUMERICAL EXAMPLE 5
UNIT: mm
SURFACE DATA

| Surface No. | r | d | nd | νd |
|---|---|---|---|---|
| 1 | 53.444 | 1.40 | 1.90525 | 35.0 |
| 2 | 30.883 | 6.25 | 1.49700 | 81.5 |
| 3 | −566.919 | 0.11 | | |
| 4 | 30.701 | 3.85 | 1.52841 | 76.5 |
| 5 | 204.366 | (Variable) | | |
| 6 | 375.602 | 0.62 | 1.88300 | 40.8 |
| 7 | 7.921 | 2.64 | | |
| 8 | 33.025 | 0.52 | 2.05090 | 26.9 |
| 9 | 17.689 | 1.60 | | |
| 10 | −36.968 | 2.34 | 1.92286 | 18.9 |
| 11 | −11.046 | 0.54 | 2.00100 | 29.1 |
| 12 | 53.067 | 0.11 | | |
| 13 | 20.504 | 1.96 | 1.92286 | 18.9 |
| 14 | −306.888 | (Variable) | | |
| 15 (SP) | ∞ | 2.95 | | |
| 16* | 13.339 | 3.18 | 1.72903 | 54.0 |
| 17* | −102.456 | 1.89 | | |
| 18 | 15.783 | 0.56 | 1.68893 | 31.1 |
| 19 | 9.449 | 3.79 | | |
| 20 | 29.182 | 2.63 | 1.69680 | 55.5 |
| 21 | −12.583 | 0.59 | 1.89286 | 20.4 |
| 22 | −26.691 | (Variable) | | |
| 23 | 189.422 | 1.67 | 1.95906 | 17.5 |
| 24 | −14.288 | 0.56 | 2.00069 | 25.5 |
| 25 | 16.050 | (Variable) | | |
| 26 | 15.982 | 3.38 | 1.80400 | 46.5 |
| 27 | −13.276 | 0.58 | 2.05090 | 26.9 |
| 28 | −32.115 | (Variable) | | |
| 29 | ∞ | 0.88 | 1.51633 | 64.1 |
| 30 | ∞ | 1.00 | | |
| Image Plane | ∞ | | | |

ASPHERIC DATA
16th Surface
K = 3.62388e−02 A 4 = −2.53227e−05
17th Surface
K = 0.00000e+00 A 4 = 5.27956e−05

VARIOUS DATA

| | |
|---|---|
| ZOOM RATIO | 23.51 |

| | WIDE | MIDDLE | TELE |
|---|---|---|---|
| Focal Length | 3.79 | 15.43 | 89.12 |
| Fno | 1.85 | 3.44 | 4.12 |
| Half Angle of View[°] | 40.07 | 11.67 | 2.05 |
| Image Height | 2.82 | 3.20 | 3.20 |
| Overall Lens Length | 99.69 | 98.06 | 106.89 |
| BF | 8.91 | 10.16 | 7.92 |
| d 5 | 0.86 | 19.10 | 36.44 |
| d14 | 37.74 | 11.43 | 1.95 |
| d22 | 0.50 | 6.95 | 7.92 |
| d25 | 7.96 | 6.71 | 8.95 |
| d28 | 7.33 | 8.58 | 6.34 |

ZOOM LENS UNIT DATA

| Lens Unit | Starting Surface | Focal Length |
|---|---|---|
| 1 | 1 | 52.43 |
| 2 | 6 | −7.05 |
| 3 | 15 | 15.76 |
| 4 | 23 | −16.70 |
| 5 | 26 | 15.93 |

NUMERICAL EXAMPLE 6
UNIT: mm
SURFACE DATA

| Surface No. | r | d | nd | νd |
|---|---|---|---|---|
| 1 | 33.371 | 1.00 | 1.85025 | 30.1 |
| 2 | 21.372 | 4.25 | 1.49700 | 81.5 |
| 3 | 88.744 | 0.10 | | |
| 4 | 30.386 | 2.14 | 1.49700 | 81.5 |
| 5 | 96.936 | 0.10 | | |
| 6 | 25.316 | 2.40 | 1.59522 | 67.7 |
| 7 | 100.767 | (Variable) | | |
| 8 | ∞ | 0.60 | 2.05090 | 26.9 |
| 9 | 7.162 | 2.30 | | |
| 10 | −56.485 | 0.50 | 2.05090 | 26.9 |
| 11 | 37.662 | 1.02 | | |
| 12 | −17.619 | 1.71 | 1.85478 | 24.8 |
| 13 | −9.063 | 0.70 | 1.88300 | 40.8 |
| 14 | 71.894 | 0.10 | | |
| 15 | 27.476 | 1.71 | 1.95906 | 17.5 |
| 16 | −28.101 | (Variable) | | |
| 17 (SP) | ∞ | (Variable) | | |
| 18* | 9.466 | 5.95 | 1.58313 | 59.4 |
| 19* | −54.869 | 0.10 | | |
| 20 | 24.236 | 0.50 | 1.88300 | 40.8 |
| 21 | 8.686 | 9.90 | | |
| 22 | 21.210 | 5.36 | 1.49700 | 81.5 |
| 23 | −10.748 | 0.50 | 2.05090 | 26.9 |
| 24 | −14.630 | (Variable) | | |
| 25 | 896.133 | 0.92 | 1.95906 | 17.5 |
| 26 | −50.642 | 0.40 | 1.95375 | 32.3 |
| 27 | 48.150 | (Variable) | | |
| 28 | −62.933 | 1.94 | 1.49700 | 81.5 |
| 29 | −13.282 | 0.50 | 2.05090 | 26.9 |
| 30 | −26.911 | 0.10 | | |
| 31 | 21.247 | 2.23 | 1.53172 | 48.8 |
| 32 | −30.450 | (Variable) | | |
| 33 | ∞ | 0.88 | 1.51633 | 64.1 |
| 34 | ∞ | 1.00 | | |
| Image Plane | ∞ | | | |

ASPHERIC DATA
18th Surface
K = 0.00000e+00 A 4 = −8.61196e−05 A 6 = 3.26653e−08
A 8 = −1.37238e−08 A10 = −1.93560e−11
19th Surface
K = 0.00000e+00 A 4 = 7.72554e−05 A 6 = 1.10521e−06
A 8 = −4.04116e−08 A10 = 4.25888e−10

VARIOUS DATA

| | |
|---|---|
| ZOOM RATIO | 19.91 |

| | WIDE | MIDDLE | TELE |
|---|---|---|---|
| Focal Length | 4.11 | 26.87 | 81.77 |
| Fno | 1.85 | 3.44 | 4.12 |
| Half Angle of View[°] | 37.98 | 6.81 | 2.24 |
| Image Height | 2.84 | 3.20 | 3.20 |
| Overall Lens Length | 110.43 | 110.43 | 110.43 |
| BF | 11.14 | 8.85 | 8.79 |
| d7 | 0.60 | 13.79 | 19.45 |
| d16 | 23.13 | 9.94 | 4.28 |
| d17 | 19.94 | 3.28 | 3.09 |
| d24 | 2.18 | 20.09 | 12.78 |
| d27 | 6.42 | 7.46 | 15.02 |
| d32 | 9.56 | 7.27 | 7.21 |

ZOOM LENS UNIT DATA

| Lens Unit | Starting Surface | Focal Length |
|---|---|---|
| 1 | 1 | 31.82 |
| 2 | 8 | −5.81 |
| 4 | 18 | 23.65 |
| 5 | 25 | −53.71 |
| 6 | 28 | 30.31 |

NUMERICAL EXAMPLE 7
UNIT: mm
SURFACE DATA

| Surface No. | r | d | nd | νd |
|---|---|---|---|---|
| 1 | 97.786 | 1.00 | 1.89190 | 37.1 |
| 2 | 45.429 | 6.19 | 1.49700 | 81.5 |
| 3 | 786.767 | 0.10 | | |
| 4 | 52.226 | 4.01 | 1.49700 | 81.5 |
| 5 | 329.218 | 0.10 | | |
| 6 | 42.530 | 3.85 | 1.49700 | 81.5 |
| 7 | 185.513 | (Variable) | | |
| 8 | ∞ | 0.60 | 2.05090 | 26.9 |
| 9 | 9.664 | 2.58 | | |
| 10 | 104.927 | 0.50 | 2.00100 | 29.1 |
| 11 | 44.205 | 1.46 | | |
| 12 | −24.396 | 1.53 | 1.95906 | 17.5 |
| 13 | −13.230 | 0.75 | 2.00100 | 29.1 |
| 14 | 69.742 | 0.10 | | |
| 15 | 28.525 | 2.47 | 1.95906 | 17.5 |
| 16 | −39.421 | (Variable) | | |
| 17 (SP) | ∞ | (Variable) | | |
| 18* | 8.722 | 6.18 | 1.58313 | 59.4 |
| 19* | −35.096 | 0.10 | | |
| 20 | −240.161 | 0.70 | 1.56732 | 42.8 |
| 21 | 7.250 | (Variable) | | |
| 22 | 12.766 | 4.45 | 1.49700 | 81.5 |
| 23 | −9.134 | 0.50 | 2.00100 | 29.1 |
| 24 | −14.229 | (Variable) | | |
| 25 | −48.866 | 0.95 | 1.95906 | 17.5 |
| 26 | −17.186 | 0.40 | 1.71736 | 29.5 |
| 27 | 19.261 | (Variable) | | |
| 28 | 15.064 | 1.76 | 1.49700 | 81.5 |
| 29 | −80.147 | (Variable) | | |
| 30 | ∞ | 1.84 | 1.51633 | 64.1 |
| 31 | ∞ | 1.00 | | |
| Image Plane | ∞ | | | |

ASPHERIC DATA
18th Surface
K = 0.00000e+00 A 4 = −7.44399e−05 A 6 = −6.93936e−07
A 8 = −9.78937e−09 A10 = −5.13832e−11
19th Surface
K = 0.00000e+00 A 4 = 1.25482e−04 A 6 = −1.02500e−06
A 8 = 1.53308e−09 A10 = 3.23692e−10

VARIOUS DATA

| | |
|---|---|
| ZOOM RATIO | 35.06 |

| | WIDE | MIDDLE | TELE |
|---|---|---|---|
| Focal Length | 4.16 | 28.70 | 145.67 |
| Fno | 1.85 | 3.44 | 4.12 |
| Half Angle of View[°] | 37.79 | 6.39 | 1.25 |
| Image Height | 2.84 | 3.20 | 3.20 |
| Overall Lens Length | 119.87 | 119.87 | 119.87 |
| BF | 9.48 | 13.70 | 8.00 |
| d7 | 1.00 | 31.00 | 43.86 |
| d16 | 44.44 | 14.44 | 1.58 |
| d17 | 12.94 | 3.38 | 3.31 |
| d21 | 5.59 | 4.70 | 4.04 |
| d24 | 2.52 | 6.15 | 3.08 |
| d27 | 3.61 | 6.22 | 15.72 |
| d29 | 7.27 | 11.48 | 5.79 |

ZOOM LENS UNIT DATA

| Lens Unit | Starting Surface | Focal Length |
|---|---|---|
| 1 | 1 | 59.95 |
| 2 | 8 | −9.14 |
| 4 | 18 | 43.66 |
| 5 | 22 | 19.04 |
| 6 | 25 | −23.22 |
| 7 | 28 | 25.67 |

NUMERICAL EXAMPLE 8
UNIT: mm
SURFACE DATA

| Surface No. | r | d | nd | νd |
|---|---|---|---|---|
| 1 | 40.612 | 0.80 | 1.99868 | 29.3 |
| 2 | 25.745 | 5.23 | 1.59522 | 67.7 |
| 3 | 952.053 | 0.11 | | |
| 4 | 26.994 | 2.67 | 1.59522 | 67.7 |
| 5 | 114.495 | (Variable) | | |
| 6 | 176.269 | 0.45 | 2.05090 | 26.9 |
| 7 | 7.823 | 2.67 | | |
| 8 | −170.688 | 0.55 | 2.05090 | 26.9 |
| 9 | 53.888 | 0.77 | | |
| 10 | −33.147 | 2.75 | 1.92286 | 18.9 |
| 11 | −8.631 | 0.54 | 1.90525 | 35.0 |
| 12 | 47.848 | 0.11 | | |
| 13 | 20.115 | 1.56 | 1.92286 | 18.9 |
| 14 | 272.011 | (Variable) | | |
| 15 (SP) | ∞ | (Variable) | | |
| 16* | 10.306 | 5.15 | 1.76802 | 49.2 |
| 17* | −633.805 | 0.11 | | |
| 18 | 19.656 | 0.55 | 2.00100 | 29.1 |
| 19 | 8.813 | 5.37 | | |
| 20 | 17.960 | 4.34 | 1.62280 | 57.0 |
| 21 | −10.521 | 0.53 | 2.05090 | 26.9 |
| 22 | −18.970 | (Variable) | | |
| 23 | 61.083 | 2.13 | 1.95906 | 17.5 |
| 24 | −16.887 | 0.54 | 2.05090 | 26.9 |
| 25 | 16.335 | (Variable) | | |
| 26 | 13.593 | 3.62 | 1.77250 | 49.6 |
| 27 | −18.028 | 0.56 | 1.92286 | 18.9 |
| 28 | −79.969 | (Variable) | | |
| 29 | ∞ | 0.88 | 1.51633 | 64.1 |
| 30 | ∞ | 1.00 | | |
| Image Plane | ∞ | | | |

ASPHERIC DATA
16th Surface
K = −2.56954e−01 A 4 = −2.62754e−05
17th Surface
K = 0.00000e+00 A 4 = 5.66685e−05

VARIOUS DATA

| | |
|---|---|
| ZOOM RATIO | 21.46 |

| | WIDE | MIDDLE | TELE |
|---|---|---|---|
| Focal Length | 3.81 | 26.24 | 81.67 |
| Fno | 1.85 | 3.44 | 4.12 |
| Half Angle of View[°] | 39.83 | 6.98 | 2.25 |
| Image Height | 2.82 | 3.20 | 3.20 |
| Overall Lens Length | 99.86 | 99.86 | 99.86 |
| BF | 8.55 | 8.16 | 7.99 |
| d5 | 0.74 | 18.62 | 26.28 |
| d14 | 26.48 | 8.60 | 0.94 |
| d15 | 14.87 | 3.50 | 3.86 |
| d22 | 0.50 | 12.55 | 11.91 |
| d25 | 7.59 | 7.31 | 7.76 |
| d28 | 6.97 | 6.58 | 6.41 |

ZOOM LENS UNIT DATA

| Lens Unit | Starting Surface | Focal Length |
|---|---|---|
| 1 | 1 | 40.16 |
| 2 | 6 | −6.36 |
| 4 | 16 | 17.65 |
| 5 | 23 | −18.97 |
| 6 | 26 | 16.81 |

NUMERICAL EXAMPLE 9
UNIT: mm
SURFACE DATA

| Surface No. | r | d | nd | νd |
|---|---|---|---|---|
| 1 | 103.265 | 1.77 | 1.92286 | 18.9 |
| 2 | 52.157 | 4.00 | 1.75500 | 52.3 |
| 3 | 142.066 | 0.26 | | |
| 4 | 65.640 | 2.26 | 1.83481 | 42.7 |
| 5 | 112.942 | 0.26 | | |
| 6 | 41.558 | 3.63 | 1.80400 | 46.5 |
| 7 | 107.235 | (Variable) | | |
| 8 | 231.557 | 0.90 | 2.00100 | 29.1 |
| 9 | 12.682 | 3.86 | | |
| 10 | −5771.418 | 0.91 | 1.96300 | 24.1 |
| 11 | 162.941 | 1.27 | | |
| 12 | −36.703 | 1.27 | 1.95906 | 17.5 |
| 13 | −28.544 | 0.91 | 1.83481 | 42.7 |
| 14 | 36.286 | 0.27 | | |
| 15 | 27.777 | 3.03 | 1.92286 | 18.9 |
| 16 | −112.289 | (Variable) | | |
| 17 (SP) | ∞ | (Variable) | | |
| 18* | 16.112 | 3.60 | 1.58313 | 59.4 |
| 19* | −117.613 | 3.99 | | |
| 20 | −93.637 | 0.91 | 1.75500 | 52.3 |
| 21 | 17.331 | 0.89 | | |
| 22 | 25.112 | 3.88 | 1.48749 | 70.2 |
| 23 | −26.836 | 0.78 | | |
| 24* | 21.790 | 4.80 | 1.49700 | 81.5 |
| 25 | −21.393 | 0.90 | 1.95906 | 17.5 |
| 26 | −29.977 | (Variable) | | |
| 27 | −107.066 | 0.90 | 1.89190 | 37.1 |
| 28 | −115.075 | 0.90 | 1.75500 | 52.3 |
| 29 | 20.039 | (Variable) | | |
| 30* | 37.607 | 3.78 | 1.49700 | 81.5 |
| 31 | −44.892 | 0.91 | 1.95375 | 32.3 |
| 32 | −51.236 | (Variable) | | |
| 33 | ∞ | 2.73 | 1.51633 | 64.1 |
| 34 | ∞ | 1.00 | | |
| Image Plane | ∞ | | | |

ASPHERIC DATA
18th Surface
K = 0.00000e+00 A 4 = −1.92139e−05
19th Surface
K = 0.00000e+00 A 4 = 4.14133e−06 A 6 = 6.56750e−08
24th Surface
K = −3.50535e+00 A 4 = 2.38315e−05 A 6 = −2.70182e−08
30th Surface
K = 7.36314e+00 A 4 = −1.94153e−05 A 6 = 2.38991e−08
A 8 = −7.76031e−10

VARIOUS DATA

| | |
|---|---|
| ZOOM RATIO | 4.35 |

| | WIDE | MIDDLE | TELE |
|---|---|---|---|
| Focal Length | 12.71 | 36.34 | 55.31 |
| Fno | 4.12 | 4.12 | 4.12 |
| Half Angle of View[°] | 40.35 | 16.43 | 10.82 |
| Image Height | 9.35 | 10.74 | 10.74 |
| Overall Lens Length | 114.72 | 114.72 | 114.72 |
| BF | 21.83 | 21.48 | 21.33 |
| d7 | 1.54 | 15.96 | 22.14 |
| d16 | 24.66 | 10.24 | 4.05 |
| d17 | 10.11 | 1.83 | 1.84 |
| d26 | 2.19 | 7.84 | 10.22 |
| d29 | 3.55 | 6.53 | 4.29 |
| d32 | 19.03 | 18.68 | 18.53 |

ZOOM LENS UNIT DATA

| Lens Unit | Starting Surface | Focal Length |
|---|---|---|
| 1 | 1 | 56.72 |
| 2 | 8 | −12.26 |
| 4 | 18 | 20.18 |
| 5 | 27 | −22.17 |
| 6 | 30 | 46.85 |

TABLE 1 below will summarize a variety of values of each numerical example.

TABLE 1

| | | NUMERICAL EXAMPLE | | | | | | | | |
|---|---|---|---|---|---|---|---|---|---|---|
| | | 1 | 2 | 3 | 4 | 5 | 6 | 7 | 8 | 9 |
| (1) | M 3/M 5 | −2.915 | −3.377 | −19.742 | −7.406 | −7.536 | −7.149 | −6.483 | −19.501 | −16.473 |
| (2) | M 2/M 3 | −2.490 | −2.369 | −2.362 | −4.008 | −3.822 | −1.119 | −4.451 | −2.318 | −2.491 |
| (3) | M 2/M 5 | 7.257 | 8.000 | 46.622 | 29.680 | 28.803 | 7.998 | 28.857 | 45.203 | 41.036 |
| (4) | d 4 5 w/b k w | 0.236 | 0.379 | 0.959 | 0.644 | 0.894 | 0.576 | 0.381 | 0.887 | 0.163 |
| (5) | f 1/f 3 | 2.466 | 2.640 | 2.273 | 2.804 | 3.326 | 1.345 | 3.073 | 2.276 | 2.811 |
| (6) | f 2/f 4 | 0.505 | 0.505 | 0.319 | 0.430 | 0.422 | 0.108 | 0.394 | 0.335 | 0.533 |
| (7) | f 3/f 4 | −1.094 | −1.146 | −0.876 | −1.003 | −0.944 | −0.440 | −0.840 | −0.930 | −0.910 |
| (8) | f 1/f 4 | −2.699 | −3.026 | −1.991 | −2.812 | −3.339 | −0.592 | −2.582 | −2.117 | −2.558 |
| (9) | N d 2 m i n | 1.72916 | 1.69680 | 1.90525 | 1.91650 | 1.88300 | 1.85478 | 1.95906 | 1.90525 | 1.83481 |
| (10) | νd 1 m i n | 40.78 | 37.13 | 28.97 | 32.32 | 35.04 | 30.05 | 37.13 | 29.30 | 18.90 |
| (11) | d 1 2 w/d 1 2 t | 0.026 | 0.028 | 0.028 | 0.02 | 0.024 | 0.031 | 0.023 | 0.028 | 0.069 |
| (12) | f 2/f M t | −0.461 | −0.440 | −0.364 | −0.429 | −0.447 | −0.246 | −0.485 | −0.361 | −0.608 |
| (13) | (β2 t/β2 w) × (βM t/βM w) | 4.004 | 3.929 | 3.441 | 4.376 | 4.565 | 17.024 | 26.984 | 21.051 | 4.330 |
| (14) | f 1/f 2 | −5.349 | −5.997 | −6.237 | −6.537 | −7.437 | −3.472 | −6.561 | −6.310 | −4.625 |
| (15) | f 1/f M t | 2.466 | 2.640 | 2.273 | 2.804 | 3.326 | 1.345 | 3.185 | 2.276 | 2.811 |
| (16) | f M t/f 4 ※ f M t/f R | −1.094 | −1.146 | −0.876 | −1.003 | −0.944 | −0.440 | −0.811 | −0.930 | −0.910 |
| (17) | f 3/f 5 | 0.705 | 0.701 | 1.052 | 0.969 | 0.990 | 0.780 | 0.760 | 1.050 | 0.431 |
| (18) | \| M 4/M 5 \| | 0.873 | 0.851 | 0.700 | 0.003 | 0.000 | 2.649 | 7.156 | 0.696 | 0.486 |
| (19) | f 4/f 5 | −0.644 | −0.612 | −1.201 | −0.966 | −1.049 | −1.772 | −0.904 | −1.075 | −1.099 |
| (20) | \| M 3/M 4 \| | 3.340 | 3.966 | 28.207 | 2754.839 | ※M4 = 0 | 2.699 | 0.906 | 28.004 | 33.882 |

### Image Pickup Apparatus

Referring now to FIG. 19, a description will be given of an embodiment of a video camera using the zoom lens according to any one of the above examples as its imaging optical system.

In FIG. 19, reference numeral 10 denotes a video camera body, and reference numeral 11 denotes an imaging optical system including of any one of the zoom lenses according to Examples 1 to 9. Reference numeral 12 denotes an image sensor such as a CCD that receives and photoelectrically converts an object image formed by the imaging optical system 11. Reference numeral 13 denotes a recorder configured to record the object image received by the image sensor 12, and reference numeral 14 denotes a viewfinder for observing the object image displayed on a display element (not illustrated). The display element may include a liquid crystal panel or the like, and the object image formed on the image sensor 12 is displayed.

Thus, applying the zoom lens according to each example to an image pickup apparatus such as a video camera can provide an image pickup apparatus that has a reduced size, high magnification, and excellent optical performance.

In a case where an electronic image sensor such as a CCD is used for the image sensor 12, aberrations can be electronically corrected to further improve the image quality of the output image.

### Imaging System

An imaging system (surveillance camera system) may include the zoom lens according to any one of the above examples and a control unit configured to control the zoom lens. In this case, the control unit can control the zoom lens so that each lens unit moves as described above during zooming, focusing, and image stabilization. The control unit may not be integrated with the zoom lens, and may be separate from the zoom lens. For example, a control unit (control apparatus) disposed remotely from the drive units that drive each lens of the zoom lens may include a transmitter configured to transmit a control signal (command) to control the zoom lens. Such a control unit allows remote control of the zoom lens.

The control unit having an operation unit such as a controller or buttons for remotely controlling the zoom lens can control the zoom lens according to user input to the operation unit. For example, an enlargement button and a reduction button may be provided as the operation unit. In this case, the control unit may be configured to send a signal to the zoom lens drive unit so that the zoom lens magnification increases when the user presses the enlargement button, and decreases when the user presses the reduction button.

The imaging system may further include a display unit such as an LCD panel configured to display information about the zoom of the zoom lens (movement state). Information about the zoom of the zoom lens includes, for example, the zoom magnification (zoom state) and the moving amount of each lens unit (movement state). The user can remotely operate the zoom lens via the operation unit while viewing the information about the zoom of the zoom lens displayed on the display unit. The display unit and operation unit may be integrated, for example, via a touch panel.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example according to the disclosure can provide a zoom lens that has a reduced size, and a higher magnification and optical performance than ever.

This application claims the benefit of Japanese Patent Application No. 2024-178565, filed on Oct. 11, 2024, Japanese Patent Application No. 2024-178590, filed on Oct. 11, 2024, and Japanese Patent Application No. 2024-178607, filed on Oct. 11, 2024, which are hereby incorporated by reference herein in their entirety.

What is claimed is:

1. A zoom lens comprising:
a plurality of lens units that include, in order from an object side to an image side, a first lens unit with positive refractive power, a second lens unit with negative refractive power, an intermediate group consisting of one or two lens units with positive refractive power, a rear unit with negative refractive power, and a final unit with positive refractive power,
wherein the second lens unit includes five or more lenses,
wherein each distance between adjacent lens units changes during zooming, and
wherein the following inequalities are satisfied:
$$- 20. \leq M 3 / M 5 \leq - 2.2$$
$$- 6. \leq M 2 / M 3 \leq - 1.5$$
where M2 is a moving amount of the second lens unit during zooming from a wide-angle end to a telephoto end, M3 is a moving amount of a lens unit disposed closest to an object in the intermediate group during zooming from the wide-angle end to the telephoto end, M5 is a moving amount of the final unit during zooming from the wide-angle end to the telephoto end, and M2, M3, and M5 have positive signs in a case where a corresponding lens unit is disposed closer to an image plane at the telephoto end than at the wide-angle end.

2. The zoom lens according to claim 1, wherein the second lens unit includes two or more positive lenses.

3. The zoom lens according to claim 1, wherein that the following inequality is satisfied:
$$6.5 \leq M 2 / M 5 \leq 51.3 .$$

4. The zoom lens according to claim 1, wherein the following inequality is satisfied:
$$0.2 \leq d 45 w / bkw \leq 1.1$$
where d45w is a distance on an optical axis from a lens surface disposed closest to the image plane in the rear unit at the wide-angle end to a lens surface disposed closest to the object in the final unit, and bkw is a back focus at the wide-angle end.

5. The zoom lens according to claim 1, wherein the following inequality is satisfied:
$$2. \leq f 1 / f 3 \leq 3.7$$
where f1 is a focal length of the first lens unit, and f3 is a focal length of the intermediate group at the wide-angle end.

6. The zoom lens according to claim 1, wherein the following inequality is satisfied:
$$0.1 \leq f 2 / f 4 \leq 0.8$$
where f2 is a focal length of the second lens unit, and f4 is a focal length of the rear unit.

7. The zoom lens according to claim 1, wherein the following inequality is satisfied:
$$- 1.5 \leq f 3 / f 4 \leq - 0.8$$
where f3 is a focal length of the intermediate group, and f4 is a focal length of the rear unit.

8. The zoom lens according to claim 1, wherein the following inequality is satisfied:
$$- 3.5 \leq f 1 / f 4 \leq - 0.5$$
where f1 is a focal length of the first lens unit, and f4 is a focal length of the rear unit.

9. The zoom lens according to claim 1, wherein the following inequality is satisfied:
$$1. 65 \leq N d 2 min \leq 2.15$$
where Nd2min is a lowest refractive index of lenses included in the second lens unit.

10. The zoom lens according to claim 1, wherein the following inequality is satisfied:
$$26. \leq vd 1 min \leq 45.$$
where vd1min is a smallest Abbe number among lenses included in the first lens unit.

11. The zoom lens according to claim 1, wherein the following inequality is satisfied:
$$0.005 \leq d 12 w / d 12 t \leq 0.100$$
where d12w is a distance on an optical axis from a lens surface disposed closest to the image plane in the first lens unit at the wide-angle end to a lens surface disposed closest to the object in the second lens unit at the wide-angle end, and d12t is a distance on the optical axis from a lens surface disposed closest to the image plane in the first lens unit at the telephoto end to a lens surface disposed closest to the object in the second lens unit at the telephoto end.

12. The zoom lens according to claim 1, wherein during zooming, the first lens unit is fixed relative to the image plane, and the second lens unit, the intermediate group, the rear unit, and the final unit move.

13. The zoom lens according to claim 1, wherein during zooming, the first lens unit, the second lens unit, the intermediate group, and the final unit move, and the rear unit is fixed relative to the image plane.

14. The zoom lens according to claim 1, wherein the second lens unit consists of, in order from the object side to the image side, a negative lens, a negative lens, a cemented lens of a positive lens and a negative lens, and a positive lens.

15. The zoom lens according to claim 1, wherein the following inequality is satisfied:
$$- 0.5 \leq f 2 / fMt \leq - 0.1$$
where f2 is a focal length of the second lens unit, and fMt is a focal length of the intermediate group at the telephoto end.

16. The zoom lens according to claim 1, wherein the following inequality is satisfied:
$$15. 0 \leq ( β 2 t / β 2 w ) \times ( β M t / β M w ) \leq 35.$$
where β2w is a lateral magnification of the second lens unit at the wide-angle end, β2t is a lateral magnification of the second lens unit at the telephoto end, βMw is a lateral magnification of the intermediate group at the wide-angle end, and βMt is a lateral magnification of the intermediate group at the telephoto end.

17. The zoom lens according to claim 1, wherein the intermediate group moves toward the object side during zooming from the wide-angle end to the telephoto end.

18. The zoom lens according to claim 1, wherein the following inequality is satisfied:
$$- 9.0 \leq f 1 / f 2 \leq - 3.$$
where f1 is a focal length of the first lens unit, and f2 is a focal length of the second lens unit.

19. The zoom lens according to claim 1, wherein the following inequality is satisfied:
$$1.1 \leq f 1 / fMt \leq 3.7$$
where f1 is a focal length of the first lens unit, and fMt is a focal length of the intermediate group at the telephoto end.

20. The zoom lens according to claim 1, wherein the following inequality is satisfied:
$$- 1.6 \leq f M t / f 4 \leq - 0.2$$
where f4 is a focal length of the rear unit, and fMt is a focal length of the intermediate group at the telephoto end.

21. The zoom lens according to claim 1, further comprising an aperture stop fixed relative to the image plane during zooming.

22. The zoom lens according to claim 1, wherein the plurality of lens units consists of, in order from the object side to the image side, the first lens unit, the second lens unit, a third lens unit with positive refractive power, a fourth lens unit with negative refractive power, and a fifth lens unit with positive refractive power.

23. The zoom lens according to claim 1, wherein the plurality of lens units consists of, in order from the object side to the image side, the first lens unit, the second lens unit, a third lens unit with positive refractive power, a fourth lens unit with positive refractive power, a fifth lens unit with negative refractive power, and a sixth lens unit with positive refractive power.

24. The zoom lens according to claim 1, wherein the following inequality is satisfied:
$$0.3 \leq f 3 / f 5 \leq 1.5$$
where f3 is a focal length of the intermediate group, and f5 is a focal length of the final unit.

25. The zoom lens according to claim 1, wherein the rear unit moves during focusing.

26. The zoom lens according to claim 1, wherein the following inequality is satisfied:
$$0. < \vert M 4 / M 5 \vert \leq 1.2$$
where M4 is a moving amount of the rear unit during zooming from the wide-angle end to the telephoto end.

27. The zoom lens according to claim 1, wherein the following inequality is satisfied:
$$- 1.5 \leq f 4 / f 5 \leq - 0.5$$
where f4 is a focal length of the rear unit, and f5 is a focal length of the final unit.

28. The zoom lens according to claim 1, wherein the following inequality:
$$2. \leq \vert M 3 / M 4 \vert \leq 40.$$
where M4 is a moving amount of the rear unit during zooming from the wide-angle end to the telephoto end.

29. An image pickup apparatus comprising:
a zoom lens; and
an image sensor configured to receive an image formed by the zoom lens,
wherein the zoom lens includes a plurality of lens units that include, in order from an object side to an image side, a first lens unit with positive refractive power, a second lens unit with negative refractive power, an intermediate group consisting of one or two lens units with positive refractive power, a rear unit with negative refractive power, and a final unit with positive refractive power,
wherein the second lens unit includes five or more lenses,
wherein each distance between adjacent lens units changes during zooming, and
wherein the following inequalities are satisfied:
$$- 20.0 \leq M 3 / M 5 \leq - 2 \text{.20}$$
$$- 6. \leq M 2 / M 3 \leq - 1.5$$
where M2 is a moving amount of the second lens unit during zooming from a wide-angle end to a telephoto end, M3 is a moving amount of a lens unit disposed closest to an object in the intermediate group during zooming from the wide-angle end to the telephoto end, M5 is a moving amount of the final unit during zooming from the wide-angle end to the telephoto end, and M2, M3, and M5 have positive signs in a case where a corresponding lens unit is disposed closer to an image plane at the telephoto end than at the wide-angle end.
